(19) United States
(12) Patent Application Publication
(10) Pub. No.: US 2024/0301170 A1
(43) Pub. Date: Sep. 12, 2024

(54) METHODS AND SYSTEMS FOR PRODUCING COMPOSITE MATERIALS

(71) Applicant: Applied Bioplastics Corp., Austin, TX (US)

(72) Inventors: Vinay KHANDELWAL, Rohini Delhi (IN); Monika BHATJIRE, Sinnar, Nashik, Maharashtra (IN); Mubarak Ahmad KHAN, Dhaka (BD); Colin ARDERN, Austin, TX (US)

(21) Appl. No.: 18/681,021

(22) PCT Filed: Aug. 5, 2022
(86) PCT No.: PCT/US2022/039616

§ 371 Date: Feb. 2, 2024

(30) Foreign Application Priority Data
Aug. 5, 2021 (IN) 202111035248

(51) Int. Cl. C08K 7/02; C08K 9/04; D06M 11/38; D07B 1/02; D07B 5/02; D07B 5/08

(52) U.S. Cl. CPC C08K 7/02; C08K 9/04; D06M 11/38; D07B 1/02; D07B 5/02; D07B 5/08; D07B 2205/103; D07B 2205/201; D10B 2201/06

(57) ABSTRACT

The present disclosure provides systems and methods for producing composite materials. The methods may comprise feeding to an extruder one or more components which may comprise a first component comprising a fiber and a second component comprising a polymer-based matrix or composite to generate a composite material. The fiber may be a biological fiber in a rope form when being directed into the extruder.

### CROSS-REFERENCE

This application claims the benefit of Indian patent application Ser. No. 20/2111035248 filed on Aug. 5, 2021 under 35 USC § 365 which is incorporated herein by reference in its entirety.

### BACKGROUND

With increasing environmental awareness and expanding global waste problems, eco-friendly materials have been recognized as an alternative to conventional materials that may be nonrenewable, recalcitrant, or manufactured by pollution emitting processes.

### SUMMARY

Plastics play a major role in the world due to their versatility, light weight, and low production cost. Plastics are key materials in sectors such as construction, medical, automotive, aerospace, leisure, electronics, packaging, food, and various other engineering sectors. Economic growth and increasing populations continue to add to the demand for plastic articles and the feedstock chemicals used in their production. In many cases, plastics are made from petroleum derived feeds such as ethylene, propylene, acrylonitrile, styrene, or para-xylene.

Biological fibers can be blended with petroleum derived polymer materials to create composites where a significant portion of the carbon is derived from renewable sources. The present disclosure provides methods and systems of generating composite materials which can be derived from renewable sources. The composite materials can be referred to as biocomposite polymers or biocomposite materials that comprise biological fibers, and binder or polymeric materials.

Plastics may be produced through the extraction and refining of crude oil, which may be energy intensive and cause environmental problems. Thus, recognized herein is a need for alternatives which can have benefits such as a lower carbon footprint. Biocomposites may be produced with low fill fractions of biological fibers due to the low bulk density and limited ability to feed biological fibers in an extrusion process. Thus, recognized herein is a need for alternatives which allow for higher fill percentages of the biological fibers and more uniform dispersion of the biological fibers.

In some aspects, the present disclosure provides a method of producing a polymer composite comprising: feeding to an extruder, a first component comprising a biological fiber in a woven rope form and a second component comprising one or more binder components to generate the polymer composite.

In some embodiments, the polymer composite can be referred to as a biocomposite polymer.

In some embodiments, the second component comprises a polymer matrix.

In some embodiments, the second component comprises a binder component.

In some embodiments, either the first component or the second component may comprise a composite polymer.

In some embodiments, the method further comprises feeding chopped or ground fibers in addition to the first component and the second component to the extruder.

In some embodiments, the first component and the second component are fed to the extruder sequentially or simultaneously.

In some embodiments, the method further comprises feeding a compatibilization agent to the extruder.

In some embodiments, the compatibilization agent comprises maleic anhydride grafted polypropylene, glycidyl methacrylate grafted polypropylene, maleic anhydride grafted elastomer, itaconic acid, or any combination thereof.

In some embodiments, the compatibilization agent does not comprise maleic-anhydride grafted polypropylene.

In some embodiments, the biological fiber is a non-wood fiber.

In some embodiments, the biological fiber comprises a mixture of one or more biological fibers.

In some embodiments, the biological fiber comprises cellulose composition of at least about 25% to about 100%, or at least about 30% to about 75%, or at least about 35% to about 65%, or at least 25%, 35%, 40%, 60%, 80%, or 100% cellulose by mass.

In some embodiments, the biological fiber comprises a lignin composition of at least about 0.60% to at least about 45%, or from 5% to 35%, or from 5% to 30%, or at least 5%, 25%, or 30% lignin by mass.

In some embodiments, the biological fiber comprises an inherent density less than or equal to about 1.6 g/cc.

In some embodiments, the biological fiber comprises average fiber length of greater than or equal to about 1 μm, or 100 μm, or 200 μm, or 500 μm, or 1 mm, or 2 mm, or 3 mm, or 4 mm, or 5 mm, or 6 mm, or 7 mm, or 8 mm, or 9 mm, or 10 mm, or 20 mm, or 50 mm, or 100 mm, or 200 mm, or 1 μm to 100 m, or 100 μm to 50 m, or 200 μm to 20 m.

In some embodiments, the biological fiber comprises hydroxyl groups along a surface of the biological fiber.

In some embodiments, the first or second component further comprises a synthetic fiber such as a glass fiber.

In some embodiments, the first or second component further comprises an inorganic mineral or carbon-based filler.

In some embodiments, the method further comprises modifying a surface of the fiber with a surface modification agent.

In some embodiments, the surface modification agent comprises one or more organosilanes such as R′nSi(OR)4-n, wherein R′ comprises an alkyl, an aryl, or an organofunctional group, and OR comprises a methoxy, an ethoxy, an acetoxy group, an organo-functional groups, or any combination thereof.

In some embodiments, the surface modification agent comprises one or more organosilanes such as γ-aminopropyltriethoxysilane, γ-methacryloxypropyltrimethoxysilane, propyl triethoxy silane, vinyltriethoxysilane, vinyltri(2-methoxy-ethoxy) silane, β-(3,4-epoxycyclohexyl)-ethyltrimethoxysilane, γ-glycidoxypropyltrimethoxysilane, γ-mercaptopropyltrimethoxysilane, n-β-(aminoethyl)-γ-aminopropyltrimethoxysilane, n-β-(aminoethoxyl)-γ-aminopropyltrimethoxysilane, γ-chloropropyltrimethoxysilane, or any combination thereof.

In some embodiments, the surface modification agent is deposited upon the surface of the fiber.

In some embodiments, the surface modification agent is deposited in an amount of between about 0.5% and about 10% with respect to the fiber weight.

In some embodiments, modifying the surface of the fiber with the surface modification agent comprises one or more of (i) hydrolyzing labile groups, (ii) self-condensing organosilanes to form oligomers, (iii) bonding the oligomers with the fiber, and (iv) removing water to form covalent bonds between the surface of the fiber and the oligomers.

In some embodiments, the surface modification agent acetylates the surface of the fiber.

In some embodiments, the surface modification agent is deposited upon the surface of the fiber anhydrously.

In some embodiments, the surface modification agent comprises NaOH, acetic acid, acetic anhydride, sulfuric acid, or any combination thereof.

In some embodiments, the woven rope form has a diameter greater than or equal to about 0.2 mm. In some embodiments, the woven rope form has a diameter less than or equal to about 80 mm.

In some embodiments, the woven rope form is continuously fed to the extruder.

In some embodiments, the woven rope form is fed to the extruder under pressure.

In some embodiments, the first component comprises bamboo sticks.

In some embodiments, the bamboo sticks have an average length of greater than or equal to about 100 μm.

In some aspects, the present disclosure describes a composition of a composite material comprising one or more biological fibers in a rope form and one or more binder components.

In some embodiments, the one or more biological fibers comprise biological fibers in a woven rope form.

In some embodiments, the one or more biological fibers comprise sisal fibers, wood fibers, softwood fibers, hardwood fibers, bamboo fibers, kenaf fibers, flax fibers, hemp hurd, hemp fibers, jute fibers, giant cane fibers, ramie fibers, coconut fibers, date palm fibers, roselle fibers, coir, cotton, kapok, wool, banana fibers, starch, palm fibers, grass, pina, bagasse, alfa, abaca fibers, aramina, areca, sunn hemp, curaua, wheat, rice, rice husk, barley, corn, corn husk, eucalyptus, henequin, hibiscus, isora, phormium, pineapple, pineapple fibers, agave fibers, fique, sorghum, luffa, swede, cassava, insects, bugs, crabs, lobsters, cellulosic fibers, silk, camel hair, horse hair, alpaca wool, cactus, elephant grass, Arundo donax, nettle, buntal, buri, soybean protein, milvet milk, linen, raffia, water hyacinth, any derivative thereof, or any combination thereof.

In some embodiments, the first or second component may comprise polyolefin, polyethylene, low density polyethylene (LDPE), high density polyethylene (HDPE), polypropylene, polystyrene, polyethylene terephthalate (PET), polyvinylchloride (PVC), polyacetylene, polybutylene, polyolefins, polybutyleneterephthalate, copolyesters, poly(p-phenylene-2,6-benzobisoxazole), ethylene vinyl alcohol, polylactic acid, polyester, polycarbonate, polyurethanes, polyamides, polyacetal, epoxies, polycyanurates, polyacrylics, polyurea, vinyl esters, polyacrylonitrile, polyvinylalcohol, polyvinyl acetate, nylon, copolymers such as: ethylene-propylene, EPDM, acrylonitrile-butadiene-styrene (ABS), nitrile rubber, natural and synthetic rubber, styrene-butadiene, styrene-acrylonitrile, styrene-isoprene, styrene-maleic anhydride, ethylene-vinylacetate, nylon Dec. 6, 1966, filled polymers, polymer composites, plastic alloys, epoxy resins, polylactic acid (PLA), polybutylene succinate (PBS), thermoplastic starch, cellulose, polyhydroxy alkanoates (PHAs), polycaprolactone (PCL), petroleum based materials, aliphatic polyesters, aliphatic-aromatic polyester blends, poly(ester amide), poly(vinyl alcohol), any variant thereof, or any combination thereof.

In some embodiments, the composition further comprises a compatibilization agent.

In some embodiments, the compatibilization agent comprises maleic anhydride grafted polypropylene (MAPP), glycidyl methacrylate grafted polypropylene (GMPP), maleic anhydride grafted elastomer, itaconic acid, or any combination thereof.

In some embodiments, the compatibilization agent does not comprise maleic-anhydride grafted polypropylene (MAPP).

In some embodiments, the composition further comprises an antioxidant.

In some embodiments, the antioxidant comprises pentaerythritol tetrakis (3-(3,5-di-tert-butyl-4-hydroxyphenyl)propionate) (antioxidant 1010), tris(2,4-di-tert.-butylphenyl) phosphite (antioxidant 168), (n-octadecyl-β-(4-hydroxy-3,5-di-tert-butyl-phenyl) propionate)(antioxidant 1076), Tris(3,5-di-tert-butyl-4-hydroxybenzyl) isocyanurate (antioxidant 3114), 2,2-Bis{[3-(dodecylthio)-1-oxopropoxy]methyl}propane-1,3-diyl bis[3-(dodecylthio)propionate] (antioxidant 412S), Distearyl thiodipropionate (DSDTP), Dilauryl thiodipropionate (DLTP), 1,3,5-Trimethyl-2,4,6-tris(3,5-di-tert-butyl-4-hydroxybenzyl) benzene (antioxidant 1330), or any combination thereof.

In some embodiments, the composite material has a biological fiber/polymer ratio of between about 90 to about 1, about 70 to about 1, about 50 to about 1, about 20 to about 1, about 10 to about 1, about 5 to about 1, about 1 to about 1, about 1 to about 2, about 1 to about 3, about 1 to about 5, about 1 to about 10, about 1 to about 50, about 1 to about 100, or from about 90:1 to about 1:200, or from about 10:1 to about 1:100, or from about 1:1 to about 1:10, or about 1:1.5 to about 1:5 by weight.

In some embodiments, the composite material comprises a surface modified with a surface modification agent.

In some embodiments, the composite material comprises a biological fiber whose surface has been modified with a surface modification agent.

In some embodiments, the composite material comprises a surface that is partially modified or fully modified.

In some embodiments, the surface of the composite material is modified with one or more functional groups.

In some embodiments, the one or more functional groups comprise a hydrophilic group, a hydrophobic group, an anionic group, an enzymatic group, a cationic group, or any combination thereof.

In some embodiments, the one or more functional groups comprise a hydroxyl group.

In some embodiments, the composite material can be coated with a hydrophobic coating, an oleophobic coating, a surface infusion coating, an antistatic coating, a scratch resistance coating, or some combination thereof.

In some aspects, the present disclosure provides a method of producing a polymer composite comprising extruding (i) a rope comprising a biological fiber and (ii) a binder component to generate said polymer composite.

In some embodiments, the method further comprises weaving, braiding, twisting, or laying said biological fiber to produce said rope comprising said biological fiber.

In some embodiments, the method further comprises cutting or grinding said rope.

In some embodiments, said biological fiber comprises an average length of greater than equal to 1 μm, or wherein said rope comprises an average length of greater than equal to 1 μm, or both.

In some embodiments, the method further comprises chopped or ground biological fibers.

In some embodiments, the method further comprises treating a surface of said rope or said biological fiber to expose more cellulose on said surface.

In some embodiments, the method further comprises treating a surface of said rope or said biological fiber to increase adhesion strength between said rope or said biological fiber and said binder component.

In some embodiments, the method further comprises treating a surface of said rope or said biological fiber to increase a density of hydroxyl functional groups exposed on said surface of said rope or said biological fiber.

In some embodiments, the method further comprises treating a surface of said rope or said biological fiber to increase dispersion of said rope or said biological fiber in said polymer composite.

In some embodiments, the method further comprises treating a surface of said rope or said biological fiber to acetylate said surface of said rope or said biological fiber.

In some embodiments, the method further comprises treating a surface of said rope or said biological fiber to functionalize said surface of said rope or said biological fiber with organosilane groups that form covalent bonds with said synthetic polymer in said polymer composite.

In some embodiments, said treating is performed anhydrously.

In some embodiments, said treating comprises contacting said rope or said biological fiber with an alkaline solution.

In some embodiments, said treating comprises bleaching, treating with a corona discharge, treating with a plasma discharge, irradiating with ultraviolet light, irradiating with gamma radiation, beating, heating, or exposing to permanganate.

In some embodiments, the method further comprises mixing a compatibilizer with said binder component.

In some embodiments, the method further comprises blending a compatibilizer with said binder component.

In some embodiments, the method further comprises extruding a compatibilizer with said rope and said binder component.

In some embodiments, said compatibilizer decreases an interfacial energy between said rope and said binder component in said polymer composite.

In some embodiments, said compatibilizer forms covalent bonds with said rope, said binder component, or both in said polymer composite.

In some embodiments, the method further comprises extruding an inorganic mineral or a carbon-based filler or a synthetic fiber with said rope and said binder component, wherein the synthetic fiber is optionally a glass fiber.

In some embodiments, the method further comprises pelletizing said polymer composite to produce pellets.

In some embodiments, the method further comprises injection molding said pellets to into a die or a mold.

In some embodiments, said biological fiber comprises a bamboo stick or a jute fiber.

In some embodiments, the method further comprises applying a hydrophobic coating, an oleophobic coating, a surface infusion coating, an antistatic coating, a scratch resistance coating, or any combination thereof to the polymer composite.

In some aspects, the present disclosure provides a polymer composite comprising (i) a binder component and (ii) a rope comprising a biological fiber distributed in said binder component.

In some embodiments, an interface between said rope and said binder component comprises a compatibilizer.

In some embodiments, an interface between said rope and said binder component comprises organosilane groups.

In some embodiments, the organosilane groups are covalently bound to said biological fiber and said binder component.

In some embodiments, said biological fiber is treated to expose more cellulose on a surface of said biological fiber.

In some embodiments, said biological fiber is treated to increase adhesion strength between said biological fiber and said binder component.

In some embodiments, said biological fiber is treated to increase a density of hydroxyl functional groups exposed on a surface of said biological fiber.

In some embodiments, said biological fiber is treated to increase dispersion of said biological fiber in said polymer composite.

In some embodiments, said biological fiber is treated to acetylate said surface of said biological fiber.

In some embodiments, said biological fiber is treated an alkaline solution.

In some embodiments, said biological fiber is treated with a corona discharge, a plasma discharge, ultraviolet light, gamma radiation, beating, heating, or permanganate exposure.

In some embodiments, the polymer composite further comprises an antioxidant.

In some embodiments, the polymer composite further comprises an impact modifier.

In some embodiments, the polymer composite further comprises a lubricant.

In some embodiments, said biological fiber comprises a bamboo stick or a jute fiber.

In some embodiments, the polymer composite comprises a pellet form or a powder form.

In some embodiments, rope or said biological fiber comprises an average length of greater than equal to 1 μm.

In some embodiments, said biological fiber comprises chopped or ground biological fibers.

In some embodiments, said biological fiber comprises cellulose.

In some embodiments, said biological fiber comprises less lignin than a virgin biological fiber.

In some embodiments, the polymer composite further comprises a hydrophobic coating, an oleophobic coating, a surface infusion coating, an antistatic coating, a scratch resistance coating, or any combination thereof.

In some aspects, the present disclosure provides a method of producing a polymer composite comprising, feeding to an extruder, a first component comprising a biological fiber in a woven rope form and a second component comprising one or more binder components to generate said polymer composite.

In some aspects, the present disclosure provides a composition of a composite material comprising one or more biological fibers in rope form and one or more binder components.

In some aspects, the present disclosure provides a method of producing a polymer composite comprising extruding (i) a chopped biological fiber and (ii) a binder component to generate said polymer composite.

In some aspects, the present disclosure provides a polymer composite comprising (i) a binder component and (ii) a chopped biological fiber distributed in said binder component.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a process diagram for producing a composite, according to some embodiments disclosed herein.

FIG. 2 illustrates a process diagram for treating the surface of biological fibers or ropes, according to some embodiments disclosed herein.

FIG. 3 illustrates a process diagram for producing a composite using a compatibilizer, according to some embodiments disclosed herein.

### DETAILED DESCRIPTION

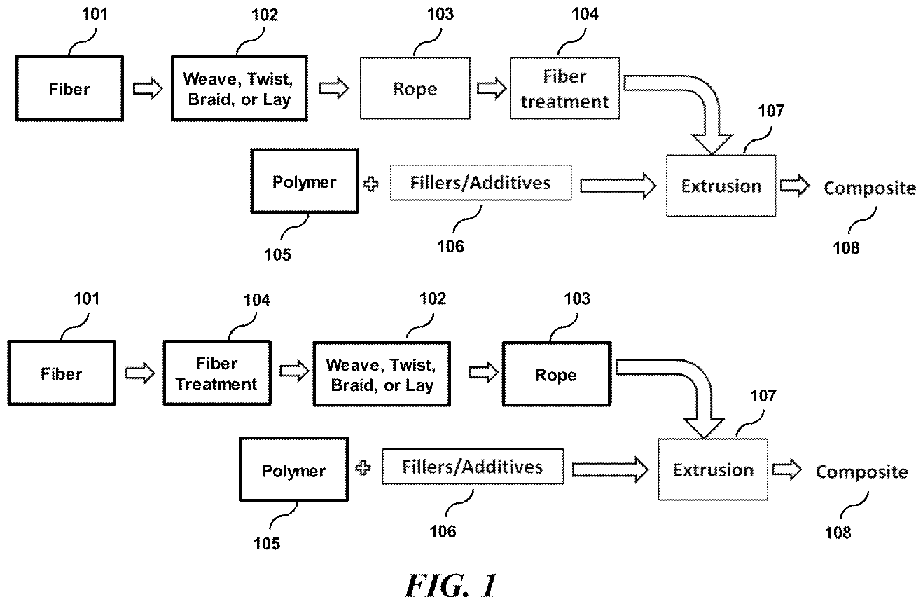

In some aspects, the present disclosure provides a composite comprising a biological fiber distributed in a polymer matrix, and methods of making the same. FIGS. 1A-1B illustrates an example process for creating composites, according to some embodiments disclosed herein. The process can comprise providing a fiber (101). The fiber (101) can be woven, twisted, braided, or laid (102) to produce a rope (103). The rope (103) or the fiber (101) can be treated (104) with any one of the various treating methods disclosed herein, for example, by washing or treating the surface of the fiber. The rope can be cut or ground to produce smaller particles or fragments of the rope. The rope can be compounded (107) with a polymer matrix (105) to produce the composite (108). The polymer can be a synthetic or bio-sourced polymer. The polymer can be blended with any one or more of the additives or fillers (106) disclosed herein, for example, a compatibilizer or a carbon-based filler. Some biological fibers, prior to processing or treating them using some of the methods described herein, can have low bulk density that is insufficient for easy or proper integration of the biological fiber into a composite with a polymer. By feeding biological fibers as a rope (which can have higher density) to a compounding machine (e.g., an extruder), more of the biological fibers can be incorporated with the polymer to form a composite that contains a high fraction of biological fibers. Biological fibers in rope form can be readily used in a composite producing process.

Biological fibers, which can be incorporated into polymer-based matrices by some of the methods described herein, can offer good mechanical strength and chemical & weathering resistance. However, some biological fibers can have numerous polar groups and as such can exhibit a high sensitivity to moisture, i.e., they can attract and absorb water. The moisture absorption by the biological fibers can affect mechanical properties, give dimensional instability, or lead to development of internal stresses in a composite comprising the biological fibers. Composites made from moist fibers can have dimensional instabilities by forming voids in the composite that adsorb or transport water through capillary action, which can cause swelling and microcracks. In some cases, water absorption and transport can result in delamination, e.g., between a less polar polymer matrix and a more polar fiber, which can severely reduce the mechanical properties of the composite. Moisture in a composite can make the composite a breeding ground for fungi, bacteria, and harmful insects. Some biological fibers can also have low thermal stability, low degradation temperature, and low fire resistance, which may confine the range of available processing temperatures. Physical and chemical modifications, as disclosed herein, can help to overcome these limitations of biological fibers in composites.

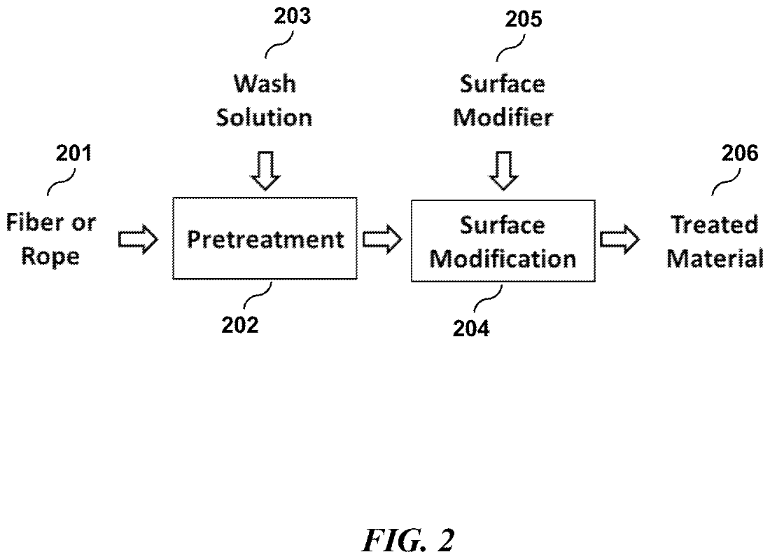

As illustrated in FIG. 2, surface properties of biological fibers can be modified by using any one of the various treating methods disclosed herein. A biological fiber, in fiber or rope form (201), can be pretreated (202). The pretreatment can comprise washing (203) the biological fiber with any one of the wash composition disclosed herein. The biological fiber, in fiber or rope form (201), can be treated (204) to modify a surface of the biological fiber. The surface modification can comprise physically or chemically modifying the surface of the biological fibers with any one of the surface modification agents (205) disclosed herein. A treated material (206) can be a treated biological fiber or a treated rope comprising the biological fiber. The treated biological fiber can be woven, twisted, braided, or laid to produce a rope, which can subsequently be processed with a polymer to form a composite. The treated rope can be processed with a polymer to form a composite.

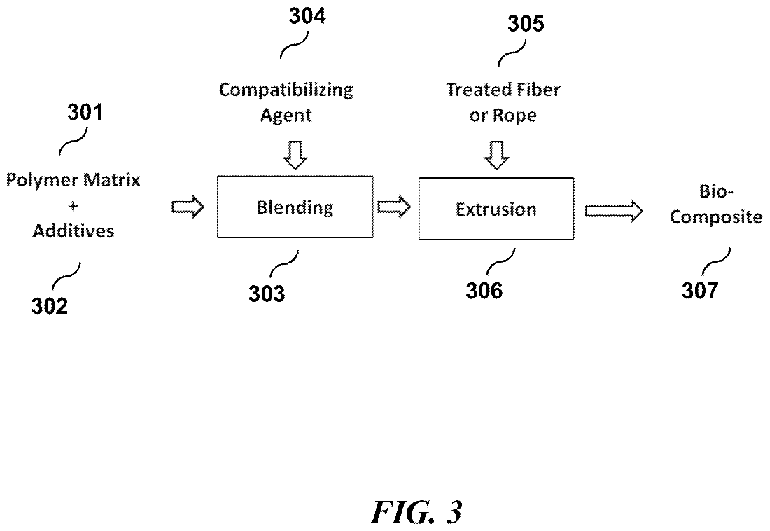

In some embodiments, the composite can comprise a compatibilizer or an additive. Some biological fibers, without using some of the methods described herein, can have incompatible chemistries with certain polymers, which can make it difficult to incorporate the biological fibers into composites. In some cases, compatibilizers can be used to improve interactions between the biological fiber or rope and the polymer matrix. The compatibilizers can be functional homopolymers or copolymers that can act to decrease the interfacial energy between the fibers and the polymer. The compatibilizers may create additional bonds with the fibers through the interaction between the functional groups of the compatibilizers and the hydroxyl groups or other polar groups of the fiber or rope. The compatibilizers can be used to (i) optimize interfacial tension, (ii) stabilize the composite morphology against high stresses during forming, and (iii) enhance adhesion between the phases in the solid state. Compatibilization may be accomplished either by addition of a compatibilizer or by reactive processing. FIG. 3 illustrates an example process for using compatibilizers, additives, or both to form composites, according to some embodiments disclosed herein. A polymer matrix (301) may be mixed with additives (302), or the polymer can be blended (303) with compatibilizers (304). Treated biological fiber or rope (305) can be processed (306, e.g., by extrusion) together with the polymer matrix to output the composite (307).

### 1. Biological Fibers

As used herein, “natural fiber”, “biological fiber”, and the like can refer to a fibrous material comprising organic polymers, sometimes referred to as macromolecules. For example, a biological fiber can refer to a fibrous material comprising carbohydrates, starch, cellulose, hemicellulose, lignin, chitosan, proteins, keratin, collagen, nucleic acids, or any combination thereof. In some cases, “natural fiber”, “biological fiber”, and the like can refer to a fibrous material derived from non-petroleum based products. For example, a non-petroleum based product can be plant-based (e.g., cotton) or animal-based (e.g., wool). A biological fiber in a composite can comprise various forms, including modified or unmodified fibers that can be incorporated into the composite as a rope during the composite forming process. In some embodiments, a biological fiber can be a “virgin” fiber which comprises a fiber harvested from a biological source that has not been chemically processed in any way, shape, or form after the harvest.

In some cases, a fiber may comprise a biological fiber or a plurality of biological fibers. In some cases, a fiber may comprise a treated biological fiber or plurality of treated biological fibers. A biological fiber can be derived from a variety of biological fiber sources that can be planted, grown, farmed, or foraged. In some cases, the biological fiber may be a non-wood fiber. In some cases, a biological fiber is not derived from petroleum or a fossil fuel source. In some cases, the biological fiber comprises a fiber from or derived from wood, bamboo, kenaf, flax, sisal, hemp, jute, giant cane, ramie, coconut, date palm, roselle, coir, cotton, kapok, wool, banana, starch, palm, grass, pina, bagasse, agave, alfa, abaca, aramina, areca, sunn hemp, curaua, wheat, rice, rice husk, barley, corn, eucalyptus, henequin, hibiscus, isora, fique, phormium, pineapple, sorghum, luffa, swede, cassava, insects, bugs, crabs, lobsters, cellulosic fibers, silk, camel hair, horse hair, alpaca wool, cactus, elephant grass, Arundo donax, nettle, buntal, buri, soybean protein, milvet milk, linen, raffia, water hyacinth, sugar cane, corn husk, or any combination thereof. Jute, hemp, kenaf, flax, bamboo, and coir fibers are preferable fibers because of their wide availability, low cost, and suitability to be made into rope.

In some cases, a biological fiber can be derived from different parts of plants or animals. A biological fiber can be derived from grasses, reeds, leaves, hardwood fibers, stems, bast fibers, pectin fibers, core fibers, straws, seeds, fruit hairs, bark, roots, or any combination thereof. In some cases, a biological fiber can be derived from sheep, goat, horse, llama, alpaca, camel, rabbit, musk oxen, yak, angora goat, cashmere goat, or any combination thereof.

A biological fiber may comprise various amounts of organic polymers. In some cases, a fiber may comprise about 5% to about 99% organic polymers, about 20% to about 97% organic polymers, or about 50% to about 95% organic polymers. In some cases, a biological fiber may comprise at least about 50%, at least about 55%, at least about 60%, at least about 65%, at least about 70%, at least about 75%, at least about 80%, at least about 85%, at least about 90%, or at least about 95% organic polymers. In some cases, a biological fiber may comprise at most about 50%, at most about 55%, at most about 60%, at most about 65%, at most about 70%, at most about 75%, at most about 80%, at most about 85%, at most about 90%, or at most about 95%, or at most about 100% organic polymers. The above percentages can be based on weight or volume.

The chemical composition of some biological fibers can comprise largely of cellulose, hemicellulose, or lignin. Some forms of cellulose in a biological fiber can have a highly crystalline structure with a theoretical Young's modulus of about 130 GPa. A biological fiber can comprise various amounts of cellulose. In some cases, a biological fiber comprises at least about 1%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95% cellulose. In some cases, a biological fiber comprises at most about 1%, at most about 5%, at most about 10%, at most about 15%, at most about 20%, at most about 25%, at most about 30%, at most about 35%, at most about 40%, at most about 45%, at most about 50%, at most about 55%, at most about 60%, at most about 65%, at most about 70%, at most about 75%, at most about 80%, at most about 85%, at most about 90%, or at most about 95%, or at most about 100% cellulose. In some cases, a biological fiber comprises about 5% to about 100% cellulose, about 20% to about 97% cellulose, or about 50% to about 95% cellulose. The above percentages can be based on weight or volume.

A biological fiber can comprise various amounts of hemicellulose. In some cases, a biological fiber comprises at least about 1%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70% hemicellulose. In some cases, a biological fiber comprises at most about 1%, at most about 5%, at most about 10%, at most about 15%, at most about 20%, at most about 25%, at most about 30%, at most about 35%, at most about 40%, at most about 45%, at most about 50%, at most about 55%, at most about 60%, at most about 65%, at most about 70%, at most about 75% hemicellulose. In some cases, a biological fiber may comprise about 10% to about 70%, from about 15 to about 65%, from about 20% to about 60%, from about 25% to about 55%, or from about 30% to about 50% hemicellulose. The above percentages can be based on weight or volume.

A biological fiber can comprise various amounts of lignin. In some cases, a biological fiber comprises at least about 1%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% lignin. In some cases, a biological fiber comprises at most about 1%, at most about 5%, at most about 10%, at most about 15%, at most about 20%, at most about 25%, at most about 30%, at most about 35%, at most about 40%, at most about 45%, at most about 50%, at most about 55%, at most about 60%, at most about 65%, at most about 70%, at most about 75%, at most about 80%, at most about 85%, at most about 90%, or at most about 95% lignin. In some cases, a biological fiber may comprise about 10% to about 75%, from about 15 to about 70%, from about 20% to about 65%, from about 25% to about 60%, or from about 30% to about 55% lignin. The above percentages can be based on weight or volume.

A biological fiber comprises various shapes, sizes, and forms. In some cases, a biological fiber can comprise tows, roving, bundles, bundles of strings, yarn, monofilaments, ropes, twists, strands of other cordage, woven rope, braided rope, twisted rope, laid rope, or any combination thereof. A twisted rope can be a S-twist rope or a Z-twist rope. In some cases, a braided rope can be a single braided rope, a double braided rope, a solid braided rope, a square braided rope, a brait rope, or a Kernmantle rope. In some cases, a biological fiber is substantially straight, curled, spiral, circular, looped, or any combination thereof. In some cases, a biological fiber is at least about 1 μm, or 100 μm, or 200 μm, or 500 μm, or 1 mm, or 2 mm, or 3 mm, or 4 mm, or 5 mm, or 6 mm, or 7 mm, or 8 mm, or 9 mm, or 10 mm, or 20 mm, or 50 mm, or 100 mm, or 200 mm, or from 1 μm to 200 mm, or from 200 μm to 100 mm or from 500 μm to 50 mm along the fiber's longest dimension. In some cases, a biological fiber is at most about 1 μm, or 100 μm, or 200 μm, or 500 μm, or 1 mm, or 2 mm, or 3 mm, or 4 mm, or 5 mm, or 6 mm, or 7 mm, or 8 mm, or 9 mm, or 10 mm, or 20 mm, or 50 mm, or 100 mm, or 200 mm, or from 1 μm to 200 mm, or from 200 μm to 100 mm or from 500 μm to 50 mm along the fiber's longest dimension. In some cases, the average thickness of the biological fiber may be at least about 10 nm, or 100 nm, or 200 nm, or 500 nm, or 1 μm, or 10 μm, or 20 μm, or 50 μm or 100 μm, or 200 μm, or 500 μm, or 1 mm, or 2 mm, or 5 mm, or from 10 nm to 5 mm, or from 1 μm to 4 mm or from 10 μm to 3 mm. In some cases, the average thickness of the biological fiber may be at most about 10 nm, or 100 nm, or 200 nm, or 500 nm, or 1 μm, or 10 μm, or 20 μm, or 50 μm or 100 μm, or 200 μm, or 500 μm, or 1 mm, or 2 mm, or 5 mm, or from 10 nm to 5 mm, or from 1 μm to 4 mm or from 10 μm to 3 mm.

The biological fiber can comprise various inherent densities. In some cases, the fiber may comprise an inherent density less than or equal to about 0.6 g/cc, about 0.7 g/cc, about 0.8 g/cc, about 0.9 g/cc, about 1 g/cc, about 1.1 g/cc, about 1.2 g/cc, about 1.3 g/cc, about 1.4 g/cc, about 1.5 g/cc, about 1.6 g/cc, or about 2.0 g/cc. In some cases, the fiber may comprise an inherent density greater than or equal to about 0.6 g/cc, about 0.7 g/cc, about 0.8 g/cc, about 0.9 g/cc, about 1 g/cc, about 1.1 g/cc, about 1.2 g/cc, about 1.3 g/cc, about 1.4 g/cc, about 1.5 g/cc, about 1.6 g/cc, or about 2.0 g/cc. In some cases, the fiber may comprise an inherent density between about 0.6 g/cc to about 2.0 g/cc, or between about 0.7 g/cc to about 1.6 g/cc.

In some cases, the biological fiber comprises bamboo sticks. In some embodiments, a bamboo stick comprises a cluster of biological fibers. In some cases, the bamboo sticks have an average length of greater than equal to about 100 μm, about 1 mm, about 2 mm, about 5 mm, about 10 mm, about 20 mm, about 50 mm, about 100 mm, or less than or equal to about 2 mm, about 5 mm, about 10 mm, about 20 mm, about 40 mm, about 80 mm, about 100 mm, or from 500 μm to 100 mm, or from 1 mm to 70 mm, or from 2 mm to 40 mm. In some cases, the biological fiber comprises jute fiber. In some cases, the jute fibers have an average length of greater than equal to about 100 μm, about 1 mm, about 2 mm, about 5 mm, about 10 mm, about 20 mm, about 50 mm, about 100 mm, or less than or equal to about 2 mm, about 5 mm, about 10 mm, about 20 mm, about 40 mm, about 80 mm, about 100 mm, or from 500 μm to 100 mm, or from 1 mm to 70 mm, or from 2 mm to 60 mm.

A biological fiber can be mechanically processed using a variety of methods before being produced into a composite. The biological fiber can be ground, chopped, drawn, cut, or sawed. In some cases, the biological fiber comprises wood flour, wood fiber, or sawdust. Biological fibers that have been mechanically processed can be used as fillers or as fibers in a composite.

In some embodiments, the fiber can be a biological fiber. In some embodiments, the biological fiber can be comprised in a rope. In some embodiments, the biological fiber can comprise a modification to make the biological fiber more compatible with a polymer in a composite. The biological fiber may comprise functional groups on its surface. In some cases, the biological fiber comprises hydroxyl groups along its surface.

A surface of the biological fiber can be treated using any one of the surface treatment methods or surface modification agents disclosed herein.

The biological fiber can be compounded with any one of the polymers disclosed herein using a variety of compounding machines or methods disclosed herein.

### 2. Ropes

As used herein, “rope”, “cordage”, and the like can refer to a material made by twisting, braiding, weaving, laying, or otherwise combining a plurality of biological or artificial fibers to form an integrated line. A rope can comprise one or more types of biological fibers (e.g., solely jute or a combination of jute and bamboo), or one or more types of biological and synthetic polymer fibers (e.g., solely jute or a combination of jute and polypropylene), or one or more types of synthetic polymer fibers (e.g., solely polyester or a combination of polyester and nylon).

In some cases, a rope can comprise one or more biological fibers. In some cases, a rope can comprise a plurality of biological fibers. In some cases, the plurality of biological fibers can be a plurality of treated biological fibers. A rope can be made from a variety of biological fiber sources that can be planted, grown, farmed, or foraged. A rope can comprise a non-wood fiber. In some cases, the rope is not derived from petroleum or a fossil fuel source.

In some cases, a biological fiber in a rope can be derived from different parts of plants or animals. A biological fiber in a rope can be derived from grasses, reeds, leaves, hardwood fibers, stems, bast fibers, pectin fibers, core fibers, straws, seeds, fruit hairs, bark, roots, or any combination thereof. In some cases, a biological fiber in a rope can be derived from the body of a sheep, goat, lama, camel, rabbit, musk oxen, yak, angora goat, cashmere goat, or any combination thereof. In some cases, a biological fiber in a rope can be derived from wood, bamboo, kenaf, flax, sisal, hemp, jute, giant cane, ramie, coconut, date palm, roselle, coir, cotton, kapok, wool, banana, starch, palm, grass, pina, bagasse, agave, alfa, abaca, aramina, areca, sunn hemp, curaua, wheat, rice, rice husk, barley, corn, eucalyptus, henequin, hibiscus, isora, fique, phromium, pineapple, sorghum, luffa, swede, cassava, insects, bugs, crabs, lobsters, cellulosic fibers, silk, camel hair, horse hair, alpaca wool, cactus, elephant grass, Arundo donax, nettle, buntal, buri, soybean protein, milvet milk, linen, raffia, water hyacinth, sugar cane, corn husk, or any combination thereof.

In some cases, a rope can have a diameter greater than or equal to about 10, 20, 30, 40, 50, 60, 70, 80, 90, 200, 300, 400, or 500 μm, or about 1, 2, 5, 10, 20, 50, or 70 mm. In some cases, a rope can have a diameter less than or equal to about 10, 20, 30, 40, 50, 60, 70, 80, 90, 100, 200, 300, 400, or 500 μm, or about 1, 2, 5, 10, 20, 50, or 80 mm. The rope can have a diameter from about 0.5 mm to about 70 mm, from about 0.7 mm to about 50 mm, from about 1 mm to about 30 mm, or from about 2 mm to about 20 mm.

A rope can be mechanically processed using a variety of methods before being produced into a composite. The rope can be ground, chopped, drawn, cut, or sawed. In some cases, the rope comprises wood flour, wood fiber, or sawdust.

A surface of the rope can be treated using any one of the surface treatment methods or surface modification agents disclosed herein.

The rope can be compounded with any one of the polymers disclosed herein using a variety of compounding machines or methods disclosed herein.

### 3. Polymers

In some cases, a polymer can provide a matrix that distributes biological fibers or ropes in a composite. In some cases, a polymer can be a non-natural or synthetic polymer. In some cases, a polymer can be a binder component that binds biological fibers or ropes with one another in a composite. In some embodiments, the polymer can comprise a modification to make the polymer more compatible with a biological fiber in a composite. In some embodiments, the polymer may comprise a compatibilizer, fiber, synthetic polymer, petroleum-derived polymer, bio-sourced polymer, or some combination thereof.

In some cases, the polymer matrix may comprise polar monomers, nonpolar monomers, protic monomers, aprotic monomers, solvophobic monomers, solvophillic monomers, or any combination thereof. In some cases, the polymer matrix may comprise a homopolymer, a copolymer, a random copolymer, a block copolymer, an alternative copolymer, a copolymer with regular repeating units, or any combination thereof. In some cases, the polymer matrix may comprise 1, 2, 3, 4, 5 or more types of monomers. In some cases, the polymer-based matrix may comprise polymers with linear topology, branched topology, star topology, dendritic topology, hyperbranched topology, bottlebrush topology, ring topology, catenated topology, or any combination thereof. In some cases, the oligomers may comprise 3-armed topology, 4-armed topology, 5-armed topology, 6-armed topology, 7-armed topology, 8-armed topology, 9-armed topology, or 10-armed topology.

In some cases, the polymer matrix may comprise a polyolefin, polyethylene, low density polyethylene (LDPE), high density polyethylene (HDPE), polypropylene, polystyrene, polyethylene terephthalate (PET), Polyvinylchloride (PVC), polyacetylene, polybutylene, polyolefins, polybutyleneterephthalate, copolyesters, poly(p-phenylene-2,6-benzobisoxazole), ethylene vinyl alcohol, polylactic acid, polyester, polycarbonate, polyurethanes, polyamides, polyacetal, epoxies, polycyanurates, polyacrylics, polyurea, vinyl esters, polyacrylonitrile, polyvinylalcohol, polyvinyl acetate, nylon, copolymers such as: ethylene-propylene, EPDM, acrylonitrile-butadiene-styrene (ABS), nitrile rubber, natural and synthetic rubber, styrene-butadiene, styrene-acrylonitrile, styrene-isoprene, styrene-maleic anhydride, ethylene-vinylacetate, nylon Dec. 6, 1966, filled polymers, polymer composites, plastic alloys, epoxy resins, polylactic acid (PLA), polybutylene succinate (PBS), thermoplastic starch, cellulose, polyhydroxy alkanoates (PHAs), polycaprolactone (PCL), petroleum based materials, aliphatic polyesters, aliphatic-aromatic polyester blends, poly(ester amide), poly(vinyl alcohol), polyamide-6, bio-based polyester, any variant thereof, any copolymers thereof, or any combination thereof. In some cases, the polymer matrix can comprise a melting or glass transition temperature less than about 250° C. In some cases, the melting point of the polymer matrix is at most 250° C., preferably under 220° C., and more preferably under 190° C. The glass transition temperature of the polymer matrix is under 250° C., preferably under 210° C., more preferably under 170° C., and most preferably under 130° C. The polymer matrix and biological fibers may be compounded at a temperature between 140° C.-230° C., advantageously between 180° C.-220° C. In some cases, an additive (e.g., a coupling agent) can be added to the process at the compounding temperature.

In some cases, the polymer matrix or polymer composite can comprise the form of pellets. In some cases, the pellets can have an average diameter of greater than or equal to about 50 μm, about 100 μm, about 200 μm, about 500 μm, about 1 mm, about 2 mm, about 5 mm, about 10 mm, about 20 mm, about 50 mm, or about 100 mm. In some cases, the pellets have an average size of less than or equal to about 50 μm, about 100 μm, about 200 μm, about 500 μm, about 1 mm, about 2 mm, about 5 mm, about 10 mm, about 20 mm, about 50 mm, about 100 mm, or from 50 μm to 100 mm, or from 70 μm to 70 mm, or from 100 μm to 50 mm, or from 0.5 mm to 10 mm, or from 1 mm to 5 mm. Average can be the mean or median.

### 4. Treatment of Biological Fibers and Ropes

Biological fibers or ropes can be physically modified to enhance the mechanical adhesion between the biological fibers or ropes with polymer matrices. Physical modification can enhance the interface between a biological fiber and a polymer matrix with only minor adjustments to the chemical properties of the biological fiber. Physical treatment methods can include exposure to corona discharge, plasma discharge, ultraviolet (UV) radiation, gamma radiation, fiber beating, or thermal treatment. These physical treatment methods can be applied to change the surface properties of biological fibers. For instance, in corona discharge or plasma discharge, an atmospheric pressure plasma can be generated in which a charge is induced on the surface of the fibers, causing surface cross-linking so that the surface energy of the fibers is improved for compatibility with a polymer. Gamma radiation treatment can be used to rearrange the internal structure of the material and reduce its hydrophilic nature, which helps with better crosslinking between the biological fibers and polymer matrix. As another example, UV treatment can be used to increase the polarity of the fiber surface, which can lead to increased wettability of the fibers and the increased ability to absorb modification materials. UV irradiation can be carried out in the presence of a photo-initiator that creates radical, cationic, or anionic species that can induce rapid curing of an added monomer to produce polymer chains that interpenetrate with the fibers at modest temperatures. The photo-initiator can comprise Azo-bis-isobutyronitrile (AIBN), Benzoyl peroxide, hydrogen peroxide, 2,2-Dimethoxy-2-phenylacetophenone, nitrogen dioxide, bis(4,4′-dimethylamino)benzophenone, benzophenone, quinones, such as 9,10-anthraquinone and camphorquinone, 2,4,6-trimethylbenzoyldiphenylphosphine oxide (TPO), Bisacylphosphine oxide (BAPO), 1-phenyl-1,2, propanedione (PPD), Ivocerin-dibenzoyl germanium (IVO), (7-ethoxy-4-methylcoumarin-3-yl) phenyliodonium hexafluoroantimonate (P3C-SB), or similar materials well known to those skilled in the art.

In a fiber-beating approach, the surface area of the fibers may be increased, the fibers may be defibrillated, and/or the fibers may be mechanically interlocked with each other. These alterations can result in an increase in the strength of biological fibers. In heat treatment, fibers can be heated up to a temperature that is close to the fiber degradation temperature. This heating can affect the physical, mechanical, and chemical properties of the fibers by reducing water content, causing chemical reactions, creating or destroying crystalline and amorphous phases, and changing the degree of polymerization of biological fibers.

Biological fibers or ropes can be heated. The biological fibers or ropes can be heated at a temperature of at least about 60, 70, 80, 90, 100, 120, 140, 160, 180, 200, 250, 300, 350, or 400° C. The biological fibers or ropes can be heated at a temperature of at most about 60, 70, 80, 90, 100, 120, 140, 160, 180, 200, 250, 300, 350, or 400° C. The biological fibers or ropes can be heated for at least about 1, 2, 3, 4, 5, 6, 7, 8, 9, 10, 15, 20, 25, or 30 minutes. The biological fibers or ropes can be heated for at least about 1, 2, 3, 4, 5, 6, 7, 8, 9, 10, 11, or 12 hours. The biological fibers or ropes can be heated for at least about 1, 2, 3, 4, 5, 6, or 7 days. The biological fibers or ropes can be heated for at most about 1, 2, 3, 4, 5, 6, 7, 8, 9, 10, 15, 20, 25, or 30 minutes. The biological fibers or ropes can be heated for at most about 1, 2, 3, 4, 5, 6, 7, 8, 9, 10, 11, or 12 hours. The biological fibers or ropes can be heated for at most about 1, 2, 3, 4, 5, 6, or 7 days.

Biological fibers or ropes can be chemically modified using a surface modification agent. Surface modification agents may cause various surface modifications on the fiber surface. In some cases, modifying the surface of the fiber with surface modification agents comprises one or more of (i) hydrolyzing labile groups, (ii) self-condensing organosilane to form oligomers, (iii) bonding the oligomers with the fiber, and (iv) removing water to form covalent bonds between the surface of the fiber and the oligomers. In some cases, the surface modification agent may be deposited upon the surface of the fiber anhydrously.

In some cases, modifying the fiber surface may comprise alkaline treatment, silane treatment, acetylation, benzoylation, acrylation, maleated compatibilizer treatment, permanganate treatment, peroxide treatment, isocyanate treatment, stearic acid treatment, sodium chlorite treatment, enzymatic treatment, fungal enzymatic treatment, bacterial enzymatic treatment, or any combination thereof. In some cases, modifying the surface of the fiber may comprise a physical treatment. In some cases, modifying the surface of the fiber may comprise corona discharge, plasma treatment, UV light treatment, fiber beating treatment, heat treatment, radiation treatment, gamma radiation treatment, or any combination thereof.

Biological fibers or ropes can be chemically modified to enhance the adhesion of biological fibers with a polymer-based matrix. The present disclosure, in some embodiments, describes methods of treating biological fibers with solutions, such as NaOH solutions. While not wishing to be bound by theory, chemical treatment processes, such as an alkaline treatment process for a biological fiber (e.g., a jute fiber) can perform at least three functions. First, the alkaline treatment can completely remove or partially remove structures including pectin, wax, lignin, and hemicellulose from the fiber, exposing more cellulose structures for improved biological fiber/polymer matrix adhesion. Second, the surface area of the biological fiber may be increased after the treatment. Third, the hydroxyl (—OH) groups on the surface of the fiber or rope may be significantly increased, which can provide more active sites for the biological fiber/polymer matrix interface bonding. Alkaline treatment may increase surface roughness of the biological fibers, which can result in better mechanical interlocking. Alkaline treatment may also increase the amount of cellulose exposed on the fiber surface by removing a certain amount of lignin, hemicellulose, wax, or oils, thus increasing the number of possible reaction sites between the biological fibers and polymer matrices. Alkaline treatment can be performed at a pH of at least 7.5, 8, 9, 10, 11, 12, 13, or 14. Alkaline treatment can be performed at a pH of at most 7.5, 8, 9, 10, 11, 12, 13, or 14. Alkaline treatment can be performed using any appropriate base, which can be strong bases or weak bases, including LiOH, NaOH, KOH, RbOH, CsOH, Mg(OH)₂, Ca(OH)₂, Sr(OH)₂, Ba(OH)₂, N(CH₃)₄OH, HNC(NH₂)₂, ammonium salts, ammonium hydroxide, alkylammonium hydroxide, or any combination thereof. In some cases, the biological fiber or rope can be treated with an acid.

In some cases, surface modification agents may comprise an alkaline treatment agent, which can have an ability to improve the surface of the biological fiber for better interaction with the polymer matrix. In some cases, surface modification agents can comprise sodium hydroxide (NaOH), ammonia, sodium hypochlorite, magnesium hydroxide, calcium hydroxide, potassium hydroxide, or any combination thereof. In some cases, surface modification agents can comprise NaOH at 0.5 wt % to 15 wt % of the basic solution In some cases, surface modification agents can comprise a pH of at least about 10 to at least about 14, at least about 8 to at least about 10, or at least about 7.1 to at least about 11. In some cases, surface modification agents can comprise KOH, Ba(OH)₂, Ca(OH)₂, or Mg(OH)₂, or any combination thereof. In some cases, surface modification agents can comprise a solvent comprising distilled water, deionized water, aqueous solutions, organic solvents, or any combination thereof.

The biological fiber may be chemically processed using a variety of methods before being produced into a composite. Biological fibers or ropes can be processed or chemically modified to enhance the adhesion of biological fibers with a polymer-based matrix. In some cases, biological fibers or ropes can be processed prior to being incorporated into the polymer matrix. In some cases, a rope or fiber may be treated with alkaline treatment, silane treatment, bleaching, detergent washing, or some combination thereof in any sequence to provide desired properties. A rope or fiber may be washed or rinsed with distilled water, deionized water, aqueous solutions, organic solvents, or any combination thereof before, after, or both before and after, chemical treatment and thoroughly dried prior to incorporation into a composite with one or more polymers.

Biological fibers or ropes can be treated with silane. Silane treatment is a type of chemical modification of a biological fiber that can create chemical links between biological fiber surfaces and a polymer matrix via siloxane bridges. At the initial stage of a silane treatment, silanols may be created using existing or added moisture from a silane containing hydrolysable alkoxy groups. One end of the created silanol can react with a cellulose OH group, and the other end can react with the polymer functional group by the condensation process. As a result of the condensation process, chemical bonds can be formed across the interface of the biological fiber and polymer portions of the composite, and this cross-linking may restrain the fiber from swelling into the matrix. In some cases, silanes may include γ-aminopropyltriethoxysilane, γ-methacryloxypropyltrimethoxysilane, propyltriethoxysilane, vinyltriethoxysilane, vinyltri(2-methoxy-ethoxy)silane, β-(3,4-epoxycyclohexyl)-ethyltrimethoxysilane, γ-glycidoxypropyltrimethoxysilane, γ-mercaptopropyltrimethoxysilane, n-β-(aminoethyl)-γ-aminopropyltrimethoxysilane, n-β-(aminoethoxyl)-γ-aminopropyltrimethoxysilane, γ-chloropropyltrimethoxysilane, or any combination thereof. The silane surface modification agent may comprise R′nSi(OR)4-n, wherein R′ may comprise an alkyl, an aryl, an organofunctional group, or any combination thereof, while OR may comprise a methoxy, an ethoxy, an acetoxy group, an organo-functional groups, or any combination thereof. The silane surface modification can comprise alkoxy hydrolysis and silanol condensation as competing reactions. The silane surface modification can be performed using various hydrolysis conditions, e.g., different solvents, temperatures, pH, and concentration of silanes, the specifics of which can be dependent on the type of silane used.

In some cases, surface modification agents may comprise an organosilane(s) having an ability to bond biological fiber with polymer matrix. The coupling mechanism can be due to two different types of moieties in silane structure R′nSi(OR)4-n. The Si(OR)3 portion after hydrolysis can react with biological fiber while the other portion is an organofunctional (amino-, epoxy-, vinyl-, etc.) group that reacts or is compatible with the polymer. R′ can contain alkyl, aryl or organofunctional groups while the “OR” group can be a methoxy, an ethoxy, or an acetoxy group, an organofunctional group, or any combination thereof. In some cases, surface modification agents can comprise γ-aminopropyltriethoxysilane, γ-methacryloxypropyltrimethoxysilane, propyl triethoxy silane, vinyltriethoxysilane, vinyltri(2-methoxy-ethoxy)silane, β-(3,4-epoxycyclohexyl)-ethyltrimethoxysilane, γ-glycidoxypropyltrimethoxysilane, γ-mercaptopropyltrimethoxysilane, n-β-(aminoethyl)-γ-aminopropyltrimethoxysilane, n-β-(aminoethoxyl)-γ-aminopropyltrimethoxysilane, γ-chloropropyltrimethoxysilane, acetic acid, acetic anhydride, sulfuric acid, or any combination thereof.

Biological fibers or ropes can be treated with acetylation. Acetylation describes a reaction that can introduce an acetyl functional group (CH₃COO—) into an organic compound. Acetylation of biological fibers can cause plasticization of cellulosic fibers. Acetylation can reduce the hygroscopic nature of biological fibers and can increase the dimensional stability of composites. Acetylated biological fiber composites can exhibit higher bio resistance. The acetylation can improve biological fiber-polymer matrix adhesion properties.

Benzoyl peroxide, (C6H5CO)2O2 (BP), and dicumyl peroxide, (C6H5C(CH3)2O)2 (DCP) are chemicals in the organic peroxide family that can be used in biological fiber surface modifications. In peroxide treatment, fibers may be coated with BP or DCP in various solvents for various durations of time. In some cases, fibers may be coated with BP or DCP in acetone solution for at least about 15 minutes, at least about 20 minutes, at least about 25 minutes, at least about 30 minutes, about 30 minutes to 5 hours, about 25 minutes to 4 hours, about 20 minutes to 3 hours, or about 15 minutes to 2 hours after alkaline pretreatment. In some cases, fibers may be coated using a solvent comprising methanol, ethanol, isopropyl alcohol, acetic acid, water, or any combination thereof. Benzoyl chloride may include a benzoyl moiety (C6H5C═O) which, when bonded to a fiber surface, can decrease the hydrophilicity and increase the thermal stability of biological fiber. This treatment can also improve biological fiber-polymer matrix adhesion properties. Acetylation of biological fibers treating with an acetylation agent can comprise using acetic anhydride and/or acetic acid to subject the biological fibers to acetylation conditions. The acetylation reaction can be carried out in the presence of an acetylation catalyst comprising a salt of an organic acid, wherein the organic acid is a carboxylic acid, phenol or a substituted phenol. The carboxylic acid can be selected from various aromatic carboxylic acids, or medium chain (e.g., C2-C20), saturated acids. Acetylation conditions can include heating to temperatures 80-150° C., in some cases in the range 100-140° C. The acetylation agent can be in a liquid phase or a gas phase. The acetylation agent can comprise an acetic acid and/or acetic anhydride, in some cases, a mixture of these two.

Biological fibers or ropes can be bleached. A biological fiber can be treated with hydrogen peroxide (H₂O₂). As an oxidizing bleaching agent, H₂O₂ can cause discoloration of fiber. Thus, a better physical appearance of composites can be obtained with incorporation of bleached fiber into the polymeric composite. Bleaching by H₂O₂ can rely on the dissociation of per hydroxyl anion HOO-which may predominantly occur under alkaline conditions. The following equation shows the formation of per hydroxyl ions from the dissociation of hydrogen peroxide in alkaline medium: H₂O₂+OH−→H2O+HOO−. These ions can attack the light absorbing chromophoric groups of lignin and cellulose (carbonyl and conjugated carbonyl groups and quinones), altering their light-absorbing properties.

Biological fibers or ropes can be treated with permanganate. Permanganate treatment of biological fiber can be carried out using KMnO4 in acidic media. Permanganate (MnO4−) ions can react with the hydroxyl group of cellulose, forming a cellulose-manganate bond that can initiate graft copolymerization. This treatment can improve chemical interlocking at the interface and can offer superior adhesion with the polymer matrix. Formation of a cellulose-manganate bond can lead to higher thermal stability of the fiber. It can also react with the —OH group of lignin and detach it from the fiber cell wall. In some cases, the acidic media comprises acetic acid, oxalic acid, nitric acid, formic acid, organic solvents such as acetone, methyl ethyl ketone, ethanol, methanol, or similar materials, or some combination thereof. In some cases, a fiber can be soaked in KMnO4 solution in acidic media with a soaking duration from at least about 5 minutes, at least about 10 minutes, at least about 20 minutes, at least about 40 minutes, at least about 60 minutes, at least about 90 minutes, or at least about 120 minutes. In some cases, the soaking duration is no more than 180 minutes, no more than 150 minutes, no more than 120 minutes, no more than 90 minutes, no more than 60 minutes, no more than 45 minutes, no more than 30 minutes, from 5 to 120 minutes, from 10 to 60 minutes, from 15 to 45 minutes, from 10 to 30 minutes, or from 15 to 45 minutes. The permanganate treatment can be performed using a solution comprising a pH between about 5.6 and about 10. The pH can be at least 5, 6, 7, 8, 9, or 10. The pH can be at most 5, 6, 7, 8, 9, or 10. The permanganate treatment can be performed at a temperature between about 0° C. and about 50° C. The stoichiometric quantity of potassium permanganate with respect to metal ion contaminants in said solution that are oxidizable by potassium permanganate in the specified pH range to insoluble forms can be varied.

Any of the surface modification treatments may be applied for various durations of time. In some cases, a surface modification treatment may be applied for at least about 30 minutes, at least about 1 hour, at least about 2 hours, at least about 5 hours, 10 hours, at least about 15 hours, or at least about 24 hours, or any combination thereof. Alkaline treatment can be performed for at least about 1, 2, 3, 4, 5, 6, 7, 8, 9, 10, 15, 20, 25, or 30 minutes. A surface modification treatment can be performed for at least about 1, 2, 3, 4, 5, 6, 7, 8, 9, 10, 11, or 12 hours. A surface modification treatment can be performed for at least about 1, 2, 3, 4, 5, 6, or 7 days. A surface modification treatment can be performed for at most about 1, 2, 3, 4, 5, 6, 7, 8, 9, 10, 15, 20, 25, or 30 minutes. A surface modification treatment can be performed for at most about 1, 2, 3, 4, 5, 6, 7, 8, 9, 10, 11, or 12 hours. A surface modification treatment can be performed for at most about 1, 2, 3, 4, 5, 6, or 7 days.

Some biological fibers, without using some of the methods described herein, can have undesirable particles or chemicals that can make it difficult for composites to achieve certain desired properties. The present disclosure, in some embodiments, describes methods of preparing the biological fibers by prewashing with detergent to remove unwanted material from the biological fibers, for example, dirt and grease. In some cases, the methods may comprise a rinse step that displaces excess wash solution with a rinse solution that comprises deionized water or wash solvent when the wash solution includes dissolved materials that need to be removed before further processing. FIG. 2 illustrates an example process for treating biological fibers, according to some embodiments disclosed herein. Fiber or rope may be pretreated in a wash solution, then treated with surface modification agents, to output treated fiber or rope.

Various biological fiber treatments can modify and improve the compatibility of the fiber with a polymer-based matrix to provide a composite with high fiber content. In some cases, the biological fiber may be pretreated or washed with water, an alcohol, a detergent solution, or any combination thereof, in any sequence. In some cases, the wash removes dirt, grease, minerals, organic coatings, oils, debris, impurities, loosely bonded materials, materials that can interfere with the process of forming a composite, materials that can detract from the desirable properties of the composite, or any combination thereof.

In some cases, a biological fiber may be modified on the surface by a chemical treatment, a physical treatment, or both to partially remove or to maximally remove lignin, hemicellulose, or other chemicals. In some cases, the chemical treatment, the physical treatment, or both may provide better fiber interactions with the polymer-based matrix. In some cases, the chemical treatment, the physical treatment, or both may enhance the dispersion of and the miscibility of the fiber with the polymer-based matrix.

Various solutions may be used to wash the biological fiber in any of the washing steps. In some cases, water, ethanol, methanol, iso-propyl alcohol, butanol, acetone, hydrogen peroxide, benzene, toluene, n-hexane, soap solution, sodium bicarbonate solution, sodium carbonate solution, surfactants, sodium dodecyl sulfate, or any combination thereof may be used to wash the biological fiber. In some cases, a detergent solution may comprise a salt of fatty acids, sodium dodecyl sulfate, a non-toxic surfactant, a naturally derived surfactant, a surfactant concentration below the critical micelle concentration, a surfactant concentration above the critical micelle concentration, or some combination thereof.

Various temperature may be used to wash the biological fiber. In some cases, the biological fiber may be washed at about room temperature. In some cases, the fiber may be washed at a temperature of at least about 20° C. or at least about 25° C. or at least about 40° C. or at least about 70° C., or at least about 90° C., or at least about 100° C., or at least about 110° C., or at least about 120° C., or at least about 150° C., or at least about 170° C., or from 20° C. to 170° C., or from 25° C. to 130° C., or from 50° C. to 110° C., or from 70° C. to about 110° C., or from 90° C. to about 110° C.

Various pressures may be used to wash the biological fiber. In some cases, the biological fiber may be washed at a pressure of at least about 100 kPa, at least about 200 kPa, at least about 500 kPa, at least about 1 MPa, at least about 2 MPa, at least about 5 MPa, or at least about 10 MPa, or from 50 kPa to 10 MPa, or from 100 kPa to 2 MPa, or from 100 kPa to 1 MPa, or from 100 kPa to 400 kPa.

Various washing methods may be used to wash the biological fiber. In some cases, the biological fiber may be washed with ultrasonication. In some cases, the biological fiber may be drawn from a continuous process that washes the biological fiber continuously in a solvent bath. In some cases, the biological fiber may be drawn from a batch process that washes the biological fiber by dipping the biological fiber into a solvent bath and stirring.

The washing step may be conducted at various points in the method. In some cases, the washing step can be conducted on the biological fiber before the biological fiber is formed into tows, roving, bundles, bundles of strings, yarn, monofilaments, ropes, twists, strands of other cordage, woven rope, braided rope, twisted rope, or any combination thereof. In some cases, the washing step can be conducted on the biological fiber after the biological fiber is formed into tows, roving, bundles, bundles of strings, yarn, monofilaments, ropes, twists, strands of other cordage, woven rope, braided rope, twisted rope, or any combination thereof. In some cases, the biological fiber may be washed both before and after forming into tows, roving, bundles, bundles of strings, yarn, monofilaments, ropes, twists, strands of other cordage, woven rope, braided rope, twisted rope, or any combination thereof.

After washing, the biological fiber may be dried using a variety of drying methods. In some cases, the drying may comprise heating, air drying, desiccant drying, applying a vacuum, sun drying, or any combination thereof. Various temperatures may be used to dry the biological fiber. In some cases, the biological fiber may be dried at about room temperature. In some cases, the biological fiber may be dried at a temperature of at least about 30° C., at least about 75° C., at least about 100° C., at least about 120° C., or at least about 150° C., or at least about 170° C. In some cases, the biological fiber may be dried at a temperature between about 30° C. to about 170° C., about 50° C. to about 130° C., about 70° C. to about 120° C., or from about 90° C. to about 110° C. The biological fiber may be dried in one or more steps. The biological fiber may be dried for various lengths of time. In some cases, the biological fiber may be dried for at least about 10 minutes, at least about 30 minutes, at least about 60 minutes, at least about 8 hours, at least about 18 hours, at least about 24 hours, at least about 48 hours, or overnight. In some cases, the biological fiber may be dried from about 5 minutes to 120 minutes, from about 30 minutes to about 90 minutes, from about 4 hours to about 48 hours, or from about 8 hours to about 24 hours.

In some cases, the biological fiber may be dried at ambient conditions which can include exposure to the sun, for at least about 8 hours, at least about 18 hours, at least about 24 hours, from about 4 hours to about 48 hours, or from about 8 hours to about 24 hours. In some cases, the biological fiber may be dried until the weight of the material is no longer changing by more than 1% in about 1 minute, about 2 minutes, about 5 minutes, about 10 minutes, about 20 minutes, about 30 minutes, about 40 minutes, about 50 minutes, about 1 hour, about 5 hours, about 10 hours, about 20 hours, about 1 day, about 2 days, or about 5 days of drying.

Various surface modification agents may be used to modify a portion of or the totality of the surface of the fiber. In some cases, surface modification agents may be deposited on the surface of the fiber. In some cases, surface modification agents may partially modify the surface of the fiber. In some cases, surface modification agents may fully modify the surface of the fiber. In some cases, surface modification agents may almost fully modify the surface of the fiber. In some cases, surface modification agents may functionalize the surface of the fiber with one or more functional groups. In some cases, the one or more functional groups may comprise a hydrophilic group, a hydrophobic group, an anionic group, a cationic group, or any combination thereof.

### 5. Additives

Some of the methods disclosed herein improve the properties of composites comprising biological fibers by incorporating an additive. In addition to the inclusion of biological fibers in the composite, a variety of additives can be included as well to enhance various properties of the composite such as strength, toughness, color, inherent density, bulk density, stiffness, heat stability, weathering resistance, UV stability, antistatic properties, scratch resistance, flame retardancy, antimicrobial action, shrinkage properties, water absorption, thermal expansion, or abrasion resistance. Some additives can be added before extruding the composite. Some additives can be added to the composite during extrusion. Some additives can be applied to the composite after extrusion. As used herein, an “additive” and an “additive agent” can be used interchangeable. For example, a “compatibilizer” and a “compatibilizing agent” can be used interchangeably, and an “antioxidant” and an “antioxidizing agent” can be used interchangeably.

In some cases, the additive can comprise a filler. In some cases, the composite may comprise one or more fillers in addition to the biological fiber. In some cases, fillers include inorganic mineral fillers such as talc, mica, Titania, wollastonite, calcium carbonate, barium sulfate, magnesium hydroxide, silica, zinc oxide, boron nitride, nanoparticles, chopped metal wire kaolin clay, dolomite, cristobalite, aluminum trihydrate, Magnetite/Hematite, pyrophyllite, gypsum, perlite, vermiculite, barite, soapstone, micaceous iron oxide, precipitated barium sulfate (Blanc fixe), montmorillonite (MMT) glass fibers, glass beads, hollow glass microspheres, or some combination thereof. In some cases, fillers may include carbon-based fillers such as carbon fiber, carbon black, carbon nanotubes, graphene, graphite nanoplatelets or some combination thereof.

Various particles sizes, shapes, and forms may comprise a filler. In some cases, a filler may comprise an approximately spherical shape, an approximately cylindrical shape, an approximately disc-like shape, an approximately plate-like shape. In some cases, a filler may be at least about 5 nm, or 10 nm, or 50 nm, or 100 nm, or 200 nm, or 500 nm, or 1 μm, or 10 μm, or 50 μm, or 100 μm, or 200 μm, or 500 μm, or 1 mm, or 2 mm, or 5 mm, or 10 mm, or 20 mm, or 50 mm, or 100 mm, or 200 mm, or 500 mm, between about 5 nm to about 500 mm, between about 10 nm to 200 mm, or between about 100 nm to about 100 mm along the filler's longest dimension. In some cases, a filler may be at least about 1 nm, or 5 nm, or 10 nm, or 50 nm, or 100 nm, or 200 nm, or 500 nm, or 1 μm, or 10 μm, or 50 μm, or 100 μm, or 200 μm, or 500 μm, or 1 mm, or 2 mm, or 5 mm, between about 1 nm to 5 mm, between about 1 nm to 4 mm, or between about 5 nm to 3 mm along the filler's shortest dimension.

Various amounts of fillers may comprise the composite. In some cases, the filler comprises at least about 1, 2, 3, 4, 5, 6, 7, 8, 9, 10, 20, 30 or 40 wt % of the composite. In some cases, the filler comprises at most about 1, 2, 3, 4, 5, 6, 7, 8, 9, 10, 20, 30, or 40 wt % of the composite.

In some cases, the additive can comprise an antioxidant. In some cases, antioxidants may be used to heat stabilize a material during an extrusion process. In some cases, antioxidants may be used to heat stabilize the material for specific applications. In some cases, the antioxidant can comprise pentaerythritol tetrakis (3-(3,5-di-tert-butyl-4-hydroxyphenyl)propionate) (antioxidant 1010), tris(2,4-di-tert.-butylphenyl)phosphite (antioxidant 168), (n-octadecyl-β-(4-hydroxy-3,5-di-tert-butyl-phenyl) propionate)(antioxidant 1076), Tris(3,5-di-tert-butyl-4-hydroxybenzyl) isocyanurate (antioxidant 3114), 2,2-Bis{[3-(dodecylthio)-1-oxopropoxy]methyl} propane-1,3-diyl bis[3-(dodecylthio)propionate] (antioxidant 412S), Distearyl thiodipropionate (DSDTP), Dilauryl thiodipropionate (DLTP), 1,3,5-Trimethyl-2,4,6-tris(3,5-di-tert-butyl-4-hydroxybenzyl) benzene (antioxidant 1330), or any combination thereof.

Various amounts of antioxidants may comprise the composite. In some cases, the antioxidant comprises between about 0.1 wt % to about 5.0 wt % or about 0.3 wt % to about 3.0 wt % of the composite. In some cases, the antioxidant comprises at least about 0.1 wt %, at least about 0.2 wt %, at least about 0.5 wt %, at least about 1.0 wt %, at least about 2.0 wt %, at least about 3.0 wt %, or at least about 5.0 wt % of the composite.

In some cases, the additive can comprise a lubricant. In some cases, lubricants may be used to provide lubrication during an extrusion process or a molding process. In some cases, lubricants can reduce friction between biological fiber and a compounding machine, an extruder screw, an extruder barrel, or an injection molding machine, which can reduce energy consumption and fiber breakage. In some cases, lubricants can improve the flow properties of the composite. In some cases, the method may comprise using a lubricant. Various lubricants for the extruder may be used without departing from the concepts provided herein. In some cases, a lubricant may comprise metal stearate, polyethylene wax, silicon wax, paraffin wax, amide wax, adipate stearate, ethylene glycol distearate, pentaerythritol tetra stearate, glycerol monostearate glycerol tristearate, glycerol monooleate, glycerol distearate, and blended complex modified fatty acid esters, or any combination thereof.

Various amounts of lubricant may be used in the method. In some cases, the amount of lubricant used may comprise at least about 0.01 wt % to at least about 10 wt %, at least about 0.05 wt % to at least about 7.0 wt %, or at least about 0.1 wt % to at least about 5.0 wt % of the composite. In some cases, the amount of lubricant used may comprise at least about 0.01 wt %, at least about 0.02 wt %, at least about 0.05 wt %, at least about 0.1 wt %, at least about 0.5 wt %, at least about 1 wt %, at least about 2 wt %, at least about 5 wt % or at least about 10 wt % of the composite.

In some cases, the additive can comprise a flame retardant. In some cases, flame retardant may be used to stop or slow down the spread of fire when a composite is ignited. In some cases, flame retardant comprises ammonium polyphosphate, zinc borate, zinc oxide, melamine phosphate, melamine cyanurate, piperazine polyphosphate, pentaerythritol phosphate, Polybrominated diphenyl ethers, hexabromocyclododecane, antimony trioxide, or some combination thereof.

Various amounts of flame retardant may comprise the composite. In some cases, the flame retardant comprises at least about 1 wt % to at least about 40 wt %, at least about 2 wt % to at least about 35 wt %, or at least about 5 wt % to at least about 30 wt % of the composite. In some cases, the flame retardant comprises at least about 5 wt %, at least about 10 wt %, at least about 15 wt %, at least about 20 wt %, at least about 30 wt %, or at least about 40 wt % of the composite.

In some cases, the additive can comprise an impact modifier. In some cases, the composite may comprise an impact modifier. In some cases, the impact modifier may comprise ethylene-propylene rubber (EPR), ethylene-propylene-diene rubber (EPDM), ethylene-butene copolymer, ethylene-octene copolymer, styrene-butadiene rubber (SBR), maleic anhydride grafted ethylene-octene copolymer, maleic anhydride grafted ethylene-butene copolymer, maleic anhydride grafted ethylene-octene copolymer, or some combination thereof.

Various amounts of impact modifier may comprise the composite. In some cases, the impact modifier comprises at least about 1 wt % to at least about 25 wt %, at least about 2 wt % to at least about 20 wt %, or at least about 5 wt % to at least about 15 wt % of the composite. In some cases, the impact modifier comprises at least about 1 wt %, at least about 2 wt %, at least about 5 wt %, at least about 10 wt %, at least about 20 wt %, or at least about 25 wt % of the composite.

In some cases, the additive can comprise a compatibilizer. In some cases, adding a compatibilizer can provide better biological fiber interactions with a polymer-based matrix. In some cases, the compatibilizer may compatibilize a fiber phase and a polymer phase in the composite. The compatibilizers can be functional homopolymers or copolymers that can act to decrease the interfacial energy between the fibers and the polymer. The compatibilizers may create additional bonds with the fibers through the interaction between the functional groups of the compatibilizers and the hydroxyl groups or other polar groups of the fiber or rope. The compatibilizers can be used to (i) optimize interfacial tension, (ii) stabilize the composite morphology against high stresses during forming, and (iii) enhance adhesion between the phases in the solid state. Compatibilization may be accomplished either by addition of a compatibilizer or by reactive processing. FIG. 3 illustrates an example process for using compatibilizers to form composites, according to some embodiments disclosed herein. Polymer matrix may be mixed with additives, and may be blended with compatibilizers. Treated or untreated biological fiber or rope may be extruded together with the polymer matrix to output the composites.

In some cases, the composite may comprise a compatibilization agent. In some cases, the method further comprises feeding a compatibilization agent to the extruder. In some cases, the compatibilization agent may comprise maleic anhydride grafted polypropylene (MAPP), glycidyl methacrylate grafted polypropylene (GMPP), maleic anhydride grafted elastomer, itaconic acid, or any combination thereof.

Various amounts of compatibilization agent may comprise the composite. In some cases, the compatibilization agent comprises at least about 0.25 wt % to at least about 10 wt % or at least about 0.5 wt % to at least about 5 wt % of the composite. In some cases, the compatibilization agent comprises at least about 0.25 wt %, at least about 0.5 wt %, at least about 1 wt %, at least about 2 wt %, at least about 5 wt %, or at least about 10 wt % of the composite.

### 6. Compounding

In some aspects, as depicted schematically in FIG. 1, the present disclosure describes a method of producing a polymer composite comprising, feeding to an extruder, a first component comprising a biological fiber and a second component comprising a polymer-based matrix to generate the polymer composite. In some aspects, the present disclosure describes a method of producing a polymer composite comprising, feeding to an extruder, a first component comprising a biological fiber in a rope form and a second component comprising a polymer-based matrix to generate the polymer composite. In some cases, the polymer composite can be produced using other methods such as compression molding, injection molding, extrusion, and mixing.

For instance, a composite material can be formed by embedding jute rope or other bast fibers into a polymer-based matrix such as polypropylene. Jute ropes can comprise jute fibers that are spun into strong threads. Jute fibers can be classified as a type of bast fiber that give jute plants their strength. The term “bast fibers” can refer to biological fibers that grow on the outside of the woody interior of the plant's stalk and underneath the bark. Jute ropes may be one of the strongest plant-based ropes made from biological fibers. Apart from being strong, jute ropes can also be very durable, while being biodegradable and providing aesthetic appeal. Jute ropes can have a wide range of applications, including but not limited to gardening, fishing, outdoor sports and adventure, and décor. The jute rope can be blended with various other fibers during the manufacturing process to make much stronger twine and rope, which can be used for boating, towing, and stair ropes. The biological fiber/polymer composites in the present disclosure may find use in various applications; in some cases, their enhanced resistance to weathering and degradation can make them preferable over some other materials.

In some cases, the polymer can be fed to the extruder simultaneously with a biological fiber or a rope. In some cases, the polymer can be fed to the extruder sequentially before or after a biological fiber or a rope.

The extruder may comprise various types of extruder configurations. In some cases, the extruder may comprise a parallel screw extruder. In some cases, the extruder may comprise a conical screw extruder. In some cases, more than one type of extruder can be used in series. The extruder can be configured to produce a variety of extrusion shapes.

The extruder may comprise a variety of screws. In some cases, the extruder may comprise a single-screw extruder. In some cases, the extruder may comprise a twin-screw extruder. In some cases, the extruder comprises a co-rotating screw, a counter-rotating screw, an intermeshing screw, a non-intermeshing screw, or any combination thereof. In some cases, the extruder comprises a co-rotating intermeshing screw. In some cases, more than one type of extruder may be used.

A screw of the extruder may comprise any diameter. In some cases, the screw may comprise a diameter of at most about 70 mm. In some cases, the screw may comprise a diameter of at most about 50 mm. In some cases, the screw may comprise a diameter of about 10 mm, about 20 mm, about 30 mm, about 40 mm, about 50 mm, about 60 mm, about 70 mm, about 80 mm, about 90 mm, about 100 mm, about 200 mm, between about 10 mm to about 200 mm, between about 15 mm to about 100 mm, between about 20 mm to about 80 mm, or between about 30 mm to about 70 mm.

A screw of the extruder may comprise any rotation speed. In some cases, the screw may comprise a rotation speed of at most about 500 rpm. In some cases, the screw may comprise a rotation speed of at most about 300 rpm. In some cases, the screw may comprise a rotation speed of no more than bout 25 rpm, about 50 rpm, about 75 rpm, about 100 rpm, about 150 rpm, about 200 rpm, about 250 rpm about 300 rpm, about 400 rpm, about 500 rpm, from 25 rpm to 500 rpm, from 100 rpm to 450 rpm, from 150 rpm to 400 rpm, or from 175 to 300 rpm.

The extruder may comprise any number of feed zones. The feed zone may convey material from a hopper. A feed zone may start at the rear of the extruder. A screw may have constant depth or variable depth in the feed zone.

The extruder may comprise any number of compression zones. In the compression zone, the root diameter of the screw may increase as compression is applied. Polymer flowing through this zone may melt. Entrapped gases and volatiles in this zone may be removed through an exhaust vent port. The compression zone may comprise barrier screws that separate molten polymer from solid polymer beads.

The extruder may comprise any number of metering zones. In a metering zone, the depth may be constant. In the metering zone, a pressure sufficient to convey material into an extrusion die may be generated.

The extruder may comprise a variety of operating conditions. In some cases, the extruder may comprise an operating temperature of at least about 100° C., at least about 110° C., at least about 120° C., at least about 140° C., at least about 150° C., at least about 180° C., at least about 200° C., at least about 260° C., no more than 100° C., no more than 150° C., no more than 200° C., no more than 260° C., no more than 300° C., from 100° C. to 300° C., from 120° C. to 290° C., from 140° C. to 270° C., or from 150° C. to 260° C.

In some cases, the rope can be fed to the extruder under pressure. In some embodiments, any one or a combination of rope, yarn, roving, braided rope, twisted rope, laid rope, or other cordage may be fed to the extruder continuously or discontinuously.

Various aspects of the present disclosure provide methods for preparing biological fiber filled composites. In some cases, a method may comprise modifying a biological fiber, and mixing or blending the modified fiber with a polymeric resin to form a composite, wherein the composite has a high content of biological fiber and sequesters a higher content of biologically derived carbon than competing composites. In some cases, a method may comprise modifying biological fibers, feeding biological fibers in the preparation of composites.

### 7. Composites

Various aspects of the present disclosure describe compositions of composites comprising biological fibers blended with other polymers. In some aspects, the present disclosure describes a composition of a composite material comprising one or more biological fibers in a rope form and one or more polymers. In some cases, composites filled with biological fibers can have enhanced levels of biological fiber incorporation. In some cases, composites may show improved mechanical properties.

Any fraction of the composite may comprise fiber. In some cases, a composite may comprise fiber amounts in the range of about 2% to about 70%, about 5% to about 60%, or about 10% to about 50% by weight. In some cases, a composite may comprise fiber amounts in the range at least about 30% at least about 40%, at least about 50% at least about 60%, or at least about 70% by weight.

Any fraction of the composite may comprise polymer-based matrix. In some cases, a composite may comprise polymer-based matrix amounts in the range of about 30% to about 98%, about 40% to about 95%, or about 50% to about 90% by weight. In some cases, a composite may comprise polypropylene in amounts in the range of about 30% to about 98%, about 40% to about 95%, or about 50% to about 90% by weight. In some cases, a composite may comprise polymer-based matrix in amounts of at least about 30%, 40%, 50%, 60%, 70%, 80%, 90%, 95%, or 97% by weight. In some cases, a composite may comprise polypropylene in amounts in the range of at least about 30%, 40%, 50%, 60%, 70%, 80%, 90%, 95%, or 97% by weight.

The composite can comprise a polymer matrix for holding materials (e.g., the biological fibers and various additives) together through surface interactions. The surface interactions can be hydrogen bonding, ionic attractions, van der Waals forces, mechanical interlocking, chemical bonds, or any combination thereof. The combination of the polymer matrix and the biological fiber can impart tolerance to environmental conditions (e.g., harsh chemical, thermal, or physical environments), certain surface appearances (e.g., surface color and surface texture), and durability to the composite (e.g., increased creep time and UV-light resistance), compared to either one of the components alone. When the composite is stressed, the polymer matrix can transfer the forces and the stresses uniformly to the fibers in the composite, which can help the composite resist the propagation of cracks, damage, and other mechanical or chemical deformities to the composite and the fibers.

In some aspects, the present disclosure describes a method of making a polymer mixing or blending component comprising: washing a fiber with a detergent solution wherein the fiber may be subject to ultrasonic sound waves such that about 1 to about 100 kg of fiber is washed in about 3 minutes to about 5 hours, contacting the detergent washed fiber with a surface modification agent to generate a modified fiber, and sizing the modified fiber to produce the polymer mixing or blending component.

Various surface modification agents may be used to modify a portion of or the totality of the surface of the composite. In some cases, surface modification agents may be deposited on the surface of the composite. In some cases, surface modification agents may partially modify the surface of the composite. In some cases, surface modification agents may fully modify the surface of the composite. In some cases, surface modification agents may almost fully modify the surface of the composite. In some cases, surface modification agents may functionalize the surface of the composite with one or more functional groups. In some cases, the one or more functional groups may comprise a hydroxyl group, a hydrophilic group, a hydrophobic group, an anionic group, a cationic group, or any combination thereof. In some cases, the surface of the composite may comprise functional groups at a density of greater than or equal to about 0.01 meq/g. In some cases, the surface of the fiber may comprise functional groups at a density of less than or equal to about 30 meq/g. In some cases, the surface of the fiber may comprise functional groups at densities from about 0.001 meq/g to about 30 meq/g, or from 0.005 meq/g to about 15 meq/g, or from about 0.01 meq/g to about 10 meq/g, or from about 0.05 to about 5 meq/g or from about 0.1 meq/g to about 1 meq/g.

Various amounts of surface modification agents may comprise the composite. In some cases, surface modification agents deposited in an amount of at least about 0.1 wt %, at least about 0.2 wt %, at least about 0.5 wt %, at least about 1 wt %, at least about 2 wt %, at least about 5 wt %, or at least about 10 wt %. In some cases, surface modification agents may be deposited in an amount of at most about 0.1 wt %, at most about 0.2 wt %, at most about 0.5 wt %, at most about 1 wt %, at most about 2 wt %, at most about 5 wt %, or at most about 10 wt %.

Various amounts of impact modifiers may comprise the composite. A composite can comprise at least about 1, 2, 3, 4, 5, 6, 7, 8, 9, 10, 15, 20, or 25 wt % of impact modifiers. A composite can comprise at most about 1, 2, 3, 4, 5, 6, 7, 8, 9, 10, 15, 20, or 25 wt % of impact modifiers.

Various amounts of flame retardants may comprise the composite. A composite can comprise at least about 1, 2, 3, 4, 5, 6, 7, 8, 9, 10, 15, 20, 25, 30, 35, or 40 wt % of flame retardants. A composite can comprise at most about 1, 2, 3, 4, 5, 6, 7, 8, 9, 10, 15, 20, 25, 30, 35, or 40 wt % of flame retardants.

Various amounts of fillers may comprise the composite. A composite can comprise at least about 1, 2, 3, 4, 5, 6, 7, 8, 9, 10, 20, 30, or 40 wt % of fillers. A composite can comprise at most about 1, 2, 3, 4, 5, 6, 7, 8, 9, 10, 20, 30, or 40 wt % of fillers.

Composites of the present disclosure can be made into various articles which require or benefit from robust, solid, flexible, and/or lightweight components. In an embodiment, composites of the present disclosure are used to produce articles fabricated by compression molding, transfer molding, injection molding, blow molding, rotational molding, casting, extrusion, calendering, coating, or thermoforming or similar processes known to those skilled in the art. In an embodiment, articles prepared from, or that include, biocomposites of the present disclosure can include building parts such as doors, windows, siding, fencing, cladding or lumber replacement parts, including those with an interior cavity or porous structure, pipes, packaging, ornamental articles, flatware, cups, saucers, plates, pitchers, bottles or other containers, kitchen appliances, toys, shoes, belts, hats, clothing, furniture, rugs, mats, auto or motorcycle parts, parts for yachts or pleasure boats, bicycle parts, tools, eyeware, toothbrushes, orthopedic appliances, including crutches, surgical belts, trusses, and splints, and the like.

### EXAMPLES

The following examples are provided to further illustrate some embodiments of the present disclosure, but are not intended to limit the scope of the disclosure; it will be understood by their exemplary nature that other procedures, methodologies, or techniques known to those skilled in the art may alternatively be used.

### Example 1: Washing Jute Fibers

This example describes an embodiment of a method for treating biological fiber such as jute fibers. Virgin extracted jute fibers (1 kg) were soaked in approximately 10-15 liters of water containing about 10-15 g of detergent powder/soap for approximately 2 hours. The jute fibers were then rinsed by running water several times over the fibers to remove detergent solution from the rope. The washed and rinsed fibers were then dried for 6 hours at 80° C. and then used for subsequent treatment steps or composite preparation.

### Example 2: Washing Jute Fibers with Ultrasonication

This example describes an embodiment of a method for treating biological fiber such as jute fibers. Jute fibers (5 kg) are soaked in 40 L of soap/detergent solution in an ultrasonic bath of 50 L capacity, 1000 W power intensity, operating at 30 kHz frequency. The solution with the jute fibers is sonicated for 30 minutes at room temperature. The solvent used can include sodium bicarbonate aqueous solution, sodium carbonate aqueous solution, or organic solvents. Thereafter, the fibers are rinsed thoroughly with running tap water to remove the detergent. The fibers are dried for a day for further treatment/process.

### Example 3: Composite Preparation

This example describes an embodiment of a method for preparing a composite comprising treated jute rope and polypropylene. Jute rope is fed into the extrusion machine from the upstream vent port. Polypropylene is fed with impact modifier, compatibilizer, antioxidant, and lubricant through the main feeder. Temperature range of the extruder is varied from 160-195° C. The extruder melts and mixes the components to produce a homogeneous mixture and produces a strand of composite material that is water cooled and then air cooled and is subsequently pelletized (cut into small pieces). The resulting pellets are fed to an injection molding machine and test specimens are made for testing properties which includes tensile strength, Young's modulus, flexural strength, impact strength, melt flow index, density, heat deflection temperature, gloss.

Various formulations are made. In different samples, polypropylene comprises 50 wt % to 90 wt %, the jute fiber comprises 10 wt % to 50 wt %, the impact modifier comprises 5 wt % to 25 wt %, the compatibilizer comprises 0.5 wt % to 10 wt %, the antioxidant comprises 0.1 wt % to 5.0 wt %, and the lubricant comprises 0.1 wt % to 10.0 wt %. The jute fiber rope is about 4 mm in diameter. The polypropylene is either homopolymer or a copolymer with a melt flow index (MFI) between 5 and 50. MFI has units of g/10 minutes.

### Example 4: Composite Preparation with Alkaline Treatment

This example describes an embodiment of a method for preparing a composite comprising using a compatibilizer. A biological fiber rope is prepared by detergent washing and then alkaline treatment with NaOH solution. A functionalized polyolefin compatibilizer, antioxidant, lubricant, impact modifier are added to a polyolefin resin. The mixture is fed into the main hopper of an extruder and the treated biological fiber rope is separately fed into the upstream exhaust vent port to prepare the composite.

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least” or “greater than” applies to each one of the numerical values in that series of numerical values.

Whenever the term “no more than,” “less than,” or “less than or equal to” precedes the first numerical value in a series of two or more numerical values, the term “no more than” or “less than” applies to each one of the numerical values in that series of numerical values.

The term “about” or “nearly” as used herein generally refers to within (plus or minus) 15%, 10%, 9%, 8%, 7%, 6%, 5%, 4%, 3%, 2%, or 1% of a designated value.

As used herein, the singular forms “a”, “an”, and “the” include plural references unless the context clearly dictates otherwise.

As used herein, the terms “polymer”, “polymers”, “oligomer”, “oligomers”, “macromolecule” and the like, can refer to molecules comprising a plurality of repeat units.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the disclosure are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

### NUMBERED EMBODIMENTS

Embodiment 1. A method of producing a polymer composite comprising, feeding to an extruder, a first component comprising a biological fiber in a woven rope form and a second component comprising one or more binder components to generate said polymer composite.
Embodiment 2. The method of embodiment 1, further comprising, prior to said feeding, mixing said first component and said second component to produce a mixture.
Embodiment 3. The method of embodiment 1 or 2, wherein said first component or said second component or both comprise a composite polymer.
Embodiment 4. The method of any one of embodiments 1-3, wherein said first component and said second component are fed to said extruder sequentially or simultaneously.
Embodiment 5. The method of any one of embodiments 1-4, further comprising, mixing said second component with a compatibilization agent.
Embodiment 6. The method of any one of embodiments 1-4, further comprising, feeding a compatibilization agent to said extruder.
Embodiment 7. The method of any one of embodiments 5-6, wherein said compatibilization agent comprises maleic anhydride grafted polypropylene, glycidyl methacrylate grafted polypropylene, maleic anhydride grafted elastomer, itaconic acid, or any combination thereof.
Embodiment 8. The method of any one of embodiments 5-6, wherein said compatibilization agent does not comprise maleic-anhydride grafted polypropylene.
Embodiment 9. The method of any one of embodiments 1-8, wherein said biological fiber comprises a biological material.
Embodiment 10. The method of embodiment 9, wherein said biological material comprises a cellulose content of at least about 25 wt % to about 100 wt %.
Embodiment 11. The method of embodiment 10, wherein said biological material comprises a cellulose content of at least about 25 wt % to at least about 60 wt %.
Embodiment 12. The method of embodiment 10, wherein said biological material comprises a cellulose content of at least about 60 wt % to about 100 wt %.
Embodiment 13. The method of embodiment 9, wherein said biological material comprises a lignin content of at least about 0.60 wt % to at least about 45 wt %.
Embodiment 14. The method of embodiment 13, wherein said biological material comprises a lignin content of at least about 0.60 wt % to at least about 20 wt %.
Embodiment 15. The method of embodiment 13, wherein said biological material comprises a lignin content of at least about 20 wt % to at least about 45 wt %.
Embodiment 16. The method of any one of embodiments 1-15, wherein said biological fiber is a non-wood fiber.
Embodiment 17. The method of any one of embodiments 1-16, wherein said biological fiber comprises fiber derived from wood, bamboo, kenaf, flax, sisal, hemp, jute, giant cane, ramie, coconut, date palm, roselle, coir, cotton, kapok, wool, banana, starch, palm, grass, pina, bagasse, agave, alfa, abaca, aramina, areca, sunn hemp, curaua, wheat, rice, rice husk, barley, corn, eucalyptus, henequin, hibiscus, isora, fique, phromium, pineapple, sorghum, luffa, swede, cassava, insects, bugs, crabs, lobsters, cellulosic fibers, silk, camel hair, horse hair, alpaca wool, cactus, elephant grass, Arundo donax, nettle, buntal, buri, soybean protein, milvet milk, linen, raffia, or any combination thereof.
Embodiment 18. The method of any one of embodiments 1-17, wherein said biological fiber comprises a mixture of one or more natural fibers.
Embodiment 19. The method of any one of embodiments 1-18, wherein said biological fiber comprises an inherent density less than or equal to about 0.2, 0.4, 0.6, 0.8, 1.0, 1.2, 1.4, 1.6, 1.8, or 2.0 g/cc.
Embodiment 20. The method of embodiment 19, wherein said biological fiber comprises an inherent density greater than or equal to about 0.2, 0.4, 0.6, 0.8, 1.0, 1.2, 1.4, 1.6, 1.8, or 2.0 g/cc.
Embodiment 21. The method of any one of embodiments 1-20, wherein said biological fiber comprises average fiber length of greater than or equal to about 1 μm.
Embodiment 22. The method of any one of embodiments 1-21, wherein said biological fiber comprises hydroxyl groups along a surface of said biological fiber.
Embodiment 23. The method of any one of embodiments 1-22, wherein said first or second component further comprises a synthetic fiber.
Embodiment 24. The method of any one of embodiments 1-23, wherein said synthetic fiber comprises a glass fiber.
Embodiment 25. The method of any one of embodiments 1-24, wherein said first or second component further comprises an inorganic mineral or carbon based filler.
Embodiment 26. The method of any one of embodiments 1-25, further comprising, prior to said feeding, cutting or grinding said biological fiber to generate a plurality of biological fiber particles.
Embodiment 27. The method of any one of embodiments 1-25, wherein said first or second component further comprises chopped or ground fibers.
Embodiment 28. The method of any one of embodiments 1-27, wherein said first component comprises bamboo sticks.
Embodiment 29. The method of embodiment 28, wherein said bamboo sticks have an average length of greater than or equal to about 100 μm.
Embodiment 30. The method of any one of embodiments 1-29, further comprising modifying a surface of said biological fiber with a surface modification agent.
Embodiment 31. The method of embodiment 30, wherein said surface modification agent comprises an alkaline solution.
Embodiment 32. The method of embodiment 31, wherein said alkaline solution increases said amount of cellulose exposed on said fiber surface by removing a certain amount of lignin, hemicellulose, wax, or oils, thus increasing said number of possible reaction sites between said biological fibers and polymer matrices.
Embodiment 33. The method of any one of embodiments 30-32, wherein said surface modification agent comprises NaOH, acetic acid, acetic anhydride, sulfuric acid, or any combination thereof.
Embodiment 34. The method of embodiment 30, wherein said surface modification agent comprises organosilanes, R′nSi(OR)4-n, wherein R′ comprises an alkyl, an aryl, or an organofunctional group, or any combination thereof, and OR comprises a methoxy, an ethoxy, an acetoxy group, an organo-functional groups, or any combination thereof.
Embodiment 35. The method of Embodiment 34, wherein said surface modification agent comprises organosilane, γ-aminopropyltriethoxysilane, γ-methacryloxypropyltrimethoxysilane, propyl triethoxy silane, vinyltriethoxysilane, vinyltri(2-methoxy-ethoxy)silane, β-(3,4-epoxycyclohexyl)-ethyltrimethoxysilane, γ-glycidoxypropyltrimethoxysilane, γ-mercaptopropyltrimethoxysilane, n-β-(aminoethyl)-γ-aminopropyltrimethoxysilane, n-β-(aminoethoxyl)-γ-aminopropyltrimethoxysilane, γ-chloropropyltrimethoxysilane, or any combination thereof.
Embodiment 36. The method of any one of embodiments 34-35, wherein said modifying said surface of said fiber with said surface modification agent comprises one or more of (i) hydrolyzing labile groups, (ii) self-condensing organosilanes to form oligomers, (iii) bonding said oligomers with said fiber, and (iv) removing water to form covalent bonds between said surface of said fiber and said oligomers.
Embodiment 37. The method of any one of embodiments 30-36, wherein said modifying of said surface of said biological fiber comprises depositing said surface modification agent on said surface of said fiber and/or irradiating said biological fiber.
Embodiment 38. The method of any one of embodiments 30-37, wherein said depositing comprises depositing said surface modification agent in an amount of at least about 0.5 wt % with respect to said weight of said biological fiber.
Embodiment 39. The method of any one of embodiments 30-38, wherein said depositing comprises depositing said surface modification agent in an amount of at most about 10 wt % with respect to said weight of said biological fiber.
Embodiment 40. The method of any one of embodiments 30-39, wherein said surface modification agent acetylates said surface of said biological fiber.
Embodiment 41. The method of any one of embodiments 30-40, wherein said depositing comprises depositing said surface modification agent on said surface of said biological fiber anhydrously.
Embodiment 42. The method of any one of embodiments 1-41, wherein said woven rope form has a diameter greater than or equal to about 0.2 mm.
Embodiment 43. The method of any one of embodiments 1-42, wherein said woven rope form has a diameter less than or equal to about 80 mm.
Embodiment 44. The method of any one of embodiments 1-43, wherein said woven rope form is continuously fed to said extruder.
Embodiment 45. The method of any one of embodiments 1-44, wherein said woven rope form is fed to said extruder under pressure.
Embodiment 46. The method of any one of embodiments 1-45, further comprising feeding to the extruder a lubricant, an impact modifier, an antioxidant, a filler, or any combination thereof.
Embodiment 47. The method of any one of embodiments 1-46, wherein the woven rope comprises a synthetic polymer fiber.
Embodiment 48. A composition of a composite material comprising one or more biological fibers in rope form and one or more binder components.
Embodiment 49. The composition of embodiment 48, wherein said one or more biological fibers comprise biological fibers in a woven rope form.
Embodiment 50. The composition of embodiment 48 or 49, wherein said one or more biological fibers comprise sisal fibers, wood fibers, softwood fibers, hardwood fibers, bamboo fibers, kenaf fibers, flax fibers, hemp hurd, hemp fibers, jute fibers, giant cane fibers, ramie fibers, coconut fibers, date palm fibers, roselle fibers, coir, cotton, kapok, wool, banana fibers, starch, palm fibers, grass, pina, bagasse, alfa, abaca fibers, aramina, areca, sunn hemp, curaua, wheat, rice, rice husk, barley, corn, corn husk, eucalyptus, henequin, hibiscus, isora, phormium, pineapple, pineapple fibers, agave fibers, fique, sorghum, luffa, swede, cassava, insects, bugs, crabs, lobsters, cellulosic fibers, silk, camel hair, horse hair, alpaca wool, cactus, elephant grass, Arundo donax, nettle, buntal, buri, soybean protein, milvet milk, linen, raffia, water hyacinth, any derivative thereof, or any combination thereof.
Embodiment 51. The composition of any one of embodiments 48-50, wherein said one or more binder components comprise polyolefins, polyethylene, low density polyethylene (LDPE), high density polyethylene (HDPE), polypropylene, polystyrene, polyethylene terephthalate (PET), polyvinylchloride (PVC), polyacetylene, polybutylene, polyolefins, polybutyleneterephthalate, copolyesters, poly(p-phenylene-2,6-benzobisoxazole), ethylene vinyl alcohol, polylactic acid, polyester, polycarbonate, polyurethanes, polyamides, polyacetal, epoxies, polycyanurates, polyacrylics, polyurea, vinyl esters, polyacrylonitrile, polyvinylalcohol, polyvinyl acetate, nylon, copolymers such as: ethylene-propylene, EPDM, acrylonitrile-butadiene-styrene (ABS), nitrile rubber, biological and synthetic rubber, styrene-butadiene, styrene-acrylonitrile, styrene-isoprene, styrene-maleic anhydride, ethylene-vinylacetate, nylon Dec. 6, 1966, filled polymers, polymer composites, plastic alloys, epoxy resins, polylactic acid (PLA), polybutylene succinate (PBS), thermoplastic starch, cellulose, polyhydroxy alkanoates (PHAs), polycaprolactone (PCL), petroleum based materials, aliphatic polyesters, aliphatic-aromatic polyester blends, poly(ester amide), poly(vinyl alcohol), any variant thereof, or any combination thereof.
Embodiment 52. The composition of any one of embodiments 48-51, wherein said composition further comprises a synthetic fiber such as a glass fiber.
Embodiment 53. The composition of any one of embodiments 48-52, further comprising an inorganic mineral or carbon-based filler.
Embodiment 54. The composition of any one of embodiments 48-53, further comprising chopped or ground fibers.
Embodiment 55. The composition of any one of embodiments 48-54, further comprising bamboo sticks.
Embodiment 56. The composition of embodiment 55, wherein said bamboo sticks have an average length of greater than or equal to about 100 μm.
Embodiment 57. The composition of any one of embodiments 48-56, further comprising a compatibilization agent.
Embodiment 58. The composition of embodiment 57, wherein said compatibilization agent comprises maleic anhydride grafted polypropylene (MAPP), glycidyl methacrylate grafted polypropylene (GMPP), maleic anhydride grafted elastomer, itaconic acid, or any combination thereof.
Embodiment 59. The composition of embodiment 57, wherein said compatibilization agent does not comprise maleic anhydride grafted polypropylene (MAPP).
Embodiment 60. The composition of any one of embodiments 48-59, wherein said composition further comprises an antioxidant.
Embodiment 61. The composition of embodiment 60, wherein said antioxidant comprises pentaerythritol tetrakis (3-(3,5-di-tert-butyl-4-hydroxyphenyl)propionate) (antioxidant 1010), tris(2,4-di-tert.-butylphenyl)phosphite (antioxidant 168), (n-octadecyl-β-(4-hydroxy-3,5-di-tert-butyl-phenyl)propionate) (antioxidant 1076), Tris(3,5-di-tert-butyl-4-hydroxybenzyl) isocyanurate (antioxidant 3114), 2,2-Bis{[3-(dodecylthio)-1-oxopropoxy]methyl} propane-1,3-diylbis[3-(dodecylthio)propionate] (antioxidant 412S), Distearyl thiodipropionate (DSDTP), Dilauryl thiodipropionate (DLTP), 1,3,5-Trimethyl-2,4,6-tris(3,5-di-tert-butyl-4-hydroxybenzyl) benzene (antioxidant 1330), or any combination thereof.
Embodiment 62. The composition of any one of embodiments 48-61, wherein said composition further comprises a flame retardant.
Embodiment 63. The composition of embodiment 62, wherein said flame retardant comprises ammonium polyphosphate, zinc borate, zinc oxide, melamine phosphate, melamine cyanurate, piperazine polyphosphate, pentaerythritol phosphate, polybrominated diphenyl ethers, hexabromocyclododecane, antimony trioxide, or any combination thereof.
Embodiment 64. The composition of any one of embodiments 48-63, wherein said composite material has a fiber/polymer ratio of between about 100:1 and about 1:200.
Embodiment 65. The composition of any one of embodiments 48-64, wherein said composite material comprises a surface modified with a surface modification agent.
Embodiment 66. The composition of embodiment 65, wherein said surface modification agent comprises a hydrophobic coating, an oleophobic coating, a surface infusion coating, an antistatic coating, a scratch resistance coating, or some combination thereof.
Embodiment 67. The composition of any one of embodiments 48-66, wherein said composite material comprises a surface that is partially modified or fully modified.
Embodiment 68. The composition of embodiment 67, wherein said surface of said composite material is modified with one or more functional groups.
Embodiment 69. The composition of embodiment 68, wherein said one or more functional groups comprise a hydrophilic group, a hydrophobic group, an anionic group, an enzymatic group, a cationic group, an affinity group, or any combination thereof.
Embodiment 70. The composition of embodiment 69, wherein said one or more functional groups comprise a hydroxyl group.
Embodiment 71. The composition of any one of embodiments 48-70, further comprising a lubricant, an impact modifier, a filler, or any combination thereof.
Embodiment 72. The composition of any one of embodiments 48-71, further comprising a synthetic fiber.
Embodiment 73. A method of producing a polymer composite comprising extruding (i) a chopped biological fiber and (ii) a binder component to generate said polymer composite.
Embodiment 74. The method of embodiment 73, wherein said chopped biological fiber comprises an average length of greater than equal to 1 μm.
Embodiment 75. The method of embodiment 73 or 74, further comprising treating a surface of said chopped biological fiber to expose more cellulose on said surface.
Embodiment 76. The method of any one of embodiments 73-75, further comprising treating a surface of said chopped biological fiber to increase adhesion strength between said chopped biological fiber and said binder component.
Embodiment 77. The method of any one of embodiments 73-76, further comprising treating a surface of said chopped biological fiber to increase a density of hydroxyl functional groups exposed on said surface of said chopped biological fiber.
Embodiment 78. The method of any one of embodiments 73-77, further comprising treating a surface of said chopped biological fiber to increase dispersion of said chopped biological fiber in said polymer composite.
Embodiment 79. The method of any one of embodiments 73-78, further comprising treating a surface of said chopped biological fiber to acetylate said surface of said chopped biological fiber.
Embodiment 80. The method of any one of embodiments 73-79, further comprising treating a surface of said chopped biological fiber to functionalize said surface of said chopped biological fiber with organosilane groups that form covalent bonds with said synthetic polymer in said polymer composite.
Embodiment 81. The method of any one of embodiments 75-80, wherein said treating is performed anhydrously.
Embodiment 82. The method of any one of embodiments 75-81, wherein said treating comprises contacting said chopped biological fiber with an alkaline solution.
Embodiment 83. The method of any one of embodiments 75-82, wherein said treating comprises bleaching, treating with a corona discharge, treating with a plasma discharge, irradiating with ultraviolet light, irradiating with gamma radiation, beating, heating, or exposing to permanganate.
Embodiment 84. The method of any one of embodiments 73-83, further comprising mixing a compatibilizer with said binder component.
Embodiment 85. The method of any one of embodiments 73-84, further comprising extruding a compatibilizer with said chopped biological fiber and said binder component.
Embodiment 86. The method of embodiment 84 or 85, wherein said compatibilizer decreases an interfacial energy between said chopped biological fiber and said binder component in said polymer composite.
Embodiment 87. The method of any one of embodiments 84-86, wherein said compatibilizer forms covalent bonds with said chopped biological fiber, said binder component, or both in said polymer composite.
Embodiment 88. The method of any one of embodiments 73-87, further comprising extruding an inorganic mineral or a carbon-based filler or a synthetic fiber with said chopped biological fiber and said binder component, wherein the synthetic fiber is optionally a glass fiber.
Embodiment 89. The method of any one of embodiments 73-88, further comprising pelletizing said polymer composite to produce pellets.
Embodiment 90. The method of embodiment 89, further comprising injection molding said pellets to into a die or a mold.
Embodiment 91. The method of any one of embodiments 73-90, wherein said chopped biological fiber comprises a bamboo stick or a jute fiber.
Embodiment 92. The method of any one of embodiments 73-91, further comprising applying a hydrophobic coating, an oleophobic coating, a surface infusion coating, an antistatic coating, a scratch resistance coating, or any combination thereof to the polymer composite.
Embodiment 93. A polymer composite comprising (i) a binder component and (ii) a chopped biological fiber distributed in said binder component.
Embodiment 94. The polymer composite of embodiment 93, wherein an interface between said chopped biological fiber and said binder component comprises a compatibilizer.
Embodiment 95. The polymer composite of embodiment 93 or 94, wherein an interface between said chopped biological fiber and said binder component comprises organosilane groups.
Embodiment 96. The polymer composite of embodiment 95, wherein the organosilane groups are covalently bound to said chopped biological fiber and said binder component.
Embodiment 97. The polymer composite of any one of embodiments 93-96, wherein said chopped biological fiber is treated to expose more cellulose on a surface of said chopped biological fiber.
Embodiment 98. The polymer composite of any one of embodiments 93-97, wherein said chopped biological fiber is treated to increase adhesion strength between said chopped biological fiber and said binder component.
Embodiment 99. The polymer composite of any one of embodiments 93-98, wherein said chopped biological fiber is treated to increase a density of hydroxyl functional groups exposed on a surface of said chopped biological fiber.
Embodiment 100. The polymer composite of any one of embodiments 93-99, wherein said chopped biological fiber is treated to increase dispersion of said chopped biological fiber in said polymer composite.
Embodiment 101. The polymer composite of any one of embodiments 93-100, wherein said chopped biological fiber is treated to acetylate said surface of said chopped biological fiber.
Embodiment 102. The polymer composite of any one of embodiments 93-101, wherein said chopped biological fiber is treated an alkaline solution.
Embodiment 103. The polymer composite of any one of embodiments 93-102, wherein said chopped biological fiber is treated with a corona discharge, a plasma discharge, ultraviolet light, gamma radiation, beating, heating, or permanganate exposure.
Embodiment 104. The polymer composite of any one of embodiments 93-103, further comprising an antioxidant.
Embodiment 105. The polymer composite of any one of embodiments 93-104, further comprising an impact modifier.
Embodiment 106. The polymer composite of any one of embodiments 93-105, further comprising a lubricant.
Embodiment 107. The polymer composite of any one of embodiments 93-106, wherein said chopped biological fiber comprises a bamboo stick or a jute fiber.
Embodiment 108. The polymer composite of any one of embodiments 93-107, comprising a pellet form or a powder form.
Embodiment 109. The polymer composite of any one of embodiments 93-108, wherein said chopped biological fiber comprises an average length of greater than equal to 1 μm.
Embodiment 110. The polymer composite of any one of embodiments 93-109, wherein said chopped biological fiber comprises cellulose.
Embodiment 111. The polymer composite of any one of embodiments 93-110, wherein said chopped biological fiber comprises less lignin than a virgin biological fiber.
Embodiment 112. The polymer composite of any one of embodiments 93-111, further comprising a hydrophobic coating, an oleophobic coating, a surface infusion coating, an antistatic coating, a scratch resistance coating, or any combination thereof.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

What is claimed is:

1. A method of producing a polymer composite comprising extruding (i) a rope comprising a biological fiber and (ii) a binder component to generate said polymer composite.

2. The method of claim 1, further comprising weaving, braiding, twisting, or laying said biological fiber to produce said rope comprising said biological fiber.

3. The method of claim 1 or 2, further comprising cutting or grinding said rope.

4. The method of any one of claims 1-3, wherein said biological fiber comprises an average length of greater than equal to 1 μm, or wherein said rope comprises an average length of greater than equal to 1 μm, or both.

5. The method of any one of claims 1-4, further comprising chopped or ground biological fibers.

6. The method of any one of claims 1-5, further comprising treating a surface of said rope or said biological fiber to expose more cellulose on said surface.

7. The method of any one of claims 1-6, further comprising treating a surface of said rope or said biological fiber to increase adhesion strength between said rope or said biological fiber and said binder component.

8. The method of any one of claims 1-7, further comprising treating a surface of said rope or said biological fiber to increase a density of hydroxyl functional groups exposed on said surface of said rope or said biological fiber.

9. The method of any one of claims 1-8, further comprising treating a surface of said rope or said biological fiber to increase dispersion of said rope or said biological fiber in said polymer composite.

10. The method of any one of claims 1-9, further comprising treating a surface of said rope or said biological fiber to acetylate said surface of said rope or said biological fiber.

11. The method of any one of claims 1-10, further comprising treating a surface of said rope or said biological fiber to functionalize said surface of said rope or said biological fiber with organosilane groups that form covalent bonds with said synthetic polymer in said polymer composite.

12. The method of any one of claims 6-11, wherein said treating is performed anhydrously.

13. The method of any one of claims 6-12, wherein said treating comprises contacting said rope or said biological fiber with an alkaline solution.

14. The method of any one of claims 6-13, wherein said treating comprises bleaching, treating with a corona discharge, treating with a plasma discharge, irradiating with ultraviolet light, irradiating with gamma radiation, beating, heating, or exposing to permanganate.

15. The method of any one of claims 1-14, further comprising mixing a compatibilizer with said binder component.

16. The method of any one of claims 1-15, further comprising extruding a compatibilizer with said rope and said binder component.

17. The method of claim 15 or 16, wherein said compatibilizer decreases an interfacial energy between said rope and said binder component in said polymer composite.

18. The method of any one of claims 15-17, wherein said compatibilizer forms covalent bonds with said rope, said binder component, or both in said polymer composite.

19. The method of any one of claims 1-18, further comprising extruding an inorganic mineral or a carbon-based filler or a synthetic fiber with said rope and said binder component, wherein the synthetic fiber is optionally a glass fiber.

20. The method of any one of claims 1-19, further comprising pelletizing said polymer composite to produce pellets.

21. The method of claim 20, further comprising injection molding said pellets to into a die or a mold.

22. The method of any one of claims 1-21, wherein said biological fiber comprises a bamboo stick or a jute fiber.

23. The method of any one of claims 1-22, further comprising applying a hydrophobic coating, an oleophobic coating, a surface infusion coating, an antistatic coating, a scratch resistance coating, or any combination thereof to the polymer composite.

24. A polymer composite comprising (i) a binder component and (ii) a rope comprising a biological fiber distributed in said binder component.

25. The polymer composite of claim 24, wherein an interface between said rope and said binder component comprises a compatibilizer.

26. The polymer composite of claim 24 or 25, wherein an interface between said rope and said binder component comprises organosilane groups.

27. The polymer composite of claim 26, wherein the organosilane groups are covalently bound to said biological fiber and said binder component.

28. The polymer composite of any one of claims 24-27, wherein said biological fiber is treated to expose more cellulose on a surface of said biological fiber.

29. The polymer composite of any one of claims 24-28, wherein said biological fiber is treated to increase adhesion strength between said biological fiber and said binder component.

30. The polymer composite of any one of claims 24-29, wherein said biological fiber is treated to increase a density of hydroxyl functional groups exposed on a surface of said biological fiber.

31. The polymer composite of any one of claims 24-30, wherein said biological fiber is treated to increase dispersion of said biological fiber in said polymer composite.

32. The polymer composite of any one of claims 24-31, wherein said biological fiber is treated to acetylate said surface of said biological fiber.

33. The polymer composite of any one of claims 24-32, wherein said biological fiber is treated an alkaline solution.

34. The polymer composite of any one of claims 24-33, wherein said biological fiber is treated with a corona discharge, a plasma discharge, ultraviolet light, gamma radiation, beating, heating, or permanganate exposure.

35. The polymer composite of any one of claims 24-34, further comprising an antioxidant.

36. The polymer composite of any one of claims 24-35, further comprising an impact modifier.

37. The polymer composite of any one of claims 24-36, further comprising a lubricant.

38. The polymer composite of any one of claims 24-37, wherein said biological fiber comprises a bamboo stick or a jute fiber.

39. The polymer composite of any one of claims 24-38, comprising a pellet form or a powder form.

40. The polymer composite of any one of claims 24-39, wherein said rope or said biological fiber comprises an average length of greater than equal to 1 μm.

41. The polymer composite of any one of claims 24-40, wherein said biological fiber comprises chopped or ground biological fibers.

42. The polymer composite of any one of claims 24-41, wherein said biological fiber comprises cellulose.

43. The polymer composite of any one of claims 24-42, wherein said biological fiber comprises less lignin than a virgin biological fiber.

44. The polymer composite of any one of claims 24-43, further comprising a hydrophobic coating, an oleophobic coating, a surface infusion coating, an antistatic coating, a scratch resistance coating, or any combination thereof.

45. A method of producing a polymer composite comprising, feeding to an extruder, a first component comprising a biological fiber in a woven rope form and a second component comprising one or more binder components to generate said polymer composite.

46. A composition of a composite material comprising one or more biological fibers in rope form and one or more binder components.

47. A method of producing a polymer composite comprising extruding (i) a chopped biological fiber and (ii) a binder component to generate said polymer composite.

48. A polymer composite comprising (i) a binder component and (ii) a chopped biological fiber distributed in said binder component.
